(19) United States
(12) Patent Application Publication
(10) Pub. No.: US 2015/0356660 A1
(43) Pub. Date: Dec. 10, 2015

(54) SIMPLIFIED ORDERING UPON ENTERING PREMISES

(71) Applicants: ISRAEL L'HEUREUX, MONACO (MC); MARK D. ALLEMAN, PORTLAND, OR (US)

(72) Inventors: ISRAEL L'HEUREUX, MONACO (MC); MARK D. ALLEMAN, PORTLAND, OR (US)

(21) Appl. No.: 14/559,720

(22) Filed: Dec. 3, 2014

Related U.S. Application Data
(63) Continuation-in-part of application No. 14/488,287, filed on Sep. 17, 2014.
Application No. 14/488,287 is a continuation-in-part of application No. 14/488,276, filed on Sep. 16, 2014.
Application No. 14/488,276 is a continuation-in-part of application No. 14/474,546, filed on Sep. 2, 2014.
(60) Provisional application No. 62/010,424, filed on Jun. 10, 2014.
(60) Provisional application No. 62/010,424, filed on Jun. 10, 2014.

(51) Int. Cl. G06Q 30/06; G06Q 30/02

(52) U.S. Cl. CPC G06Q 30/0631; G06Q 30/0281; G06Q 30/0255; G06Q 30/0261; G06Q 30/0267; G06Q 30/0269

(57) ABSTRACT

A computing system includes an on-premises server system and on-premises wireless access point (WAP) providing wireless local area network (WLAN) coverage to the physical premises of a store. The computing system obtains an identifier of a wireless device included in wireless communications received from a wireless device via the on-premises WAP over the WLAN. The computing system identifies a target customer profile from among customer profiles stored at a database based on the identifier of the wireless device associated with the target customer profile. The computing system determines an in-store message that identifies a recommended on-sale item that is selected based on the target customer profile. The in-store message is sent to the wireless device that identifies the recommended on-sale item and includes a selector that enables the customer to purchase the item using the customer's financial information previously associated with the target customer profile.

### CROSS-REFERENCE TO RELATED APPLICATIONS

The present application is a continuation-in-part application of and claims priority to U.S. non-provisional application Ser. No. 14/488,287, titled CROSS STORE CUSTOMER RECOGNITION, filed Sep. 17, 2014, which is a continuation-in-part application of and claims priority to U.S. non-provisional application Ser. No. 14/488,276, titled DUAL CLOUD ARCHITECTURE FOR ROBUST IN-STORE CUSTOMER INTERACTION, filed Sep. 16, 2014, which is a continuation-in-part application of and claims priority to U.S. non-provisional application Ser. No. 14/474,546, titled CUSTOMER FACING DISPLAY WITH CUSTOMER INTERACTION FOR ORDER SPECIFICATION, filed Sep. 2, 2014, which is a non-provisional application of and claims priority to U.S. provisional application Ser. No. 62/010,424, titled ENHANCED CUSTOMER INTERACTION FOR PUBLIC ACCOMMODATIONS VIA ON-PREMISES NETWORKING, filed Jun. 10, 2014, the entire contents of each of these applications are incorporated herein by reference in their entirety for all purposes.

The present application is also a continuation-in-part application of and claims priority individually and directly to each of: U.S. non-provisional application Ser. No. 14/488,276, titled DUAL CLOUD ARCHITECTURE FOR ROBUST IN-STORE CUSTOMER INTERACTION, filed Sep. 16, 2014, and U.S. non-provisional application Ser. No. 14/474,546, titled CUSTOMER FACING DISPLAY WITH CUSTOMER INTERACTION FOR ORDER SPECIFICATION, filed Sep. 2, 2014, the entire contents of each of these applications are incorporated herein by reference in their entirety for all purposes.

The present application is also a non-provisional application of and claims priority directly to U.S. provisional application Ser. No. 62/010,424, titled ENHANCED CUSTOMER INTERACTION FOR PUBLIC ACCOMMODATIONS VIA ON-PREMISES NETWORKING, filed Jun. 10, 2014, the entire contents of which are incorporated herein by reference in their entirety for all purposes.

### BACKGROUND

Currently, many public accommodations, including stores, restaurants, airports, train stations, stadiums, theaters, parks, amusement parks, hotels, museums, etc. offer wireless network access (e.g., Wi-Fi) to their customers and patrons via an on-premises wireless access point. Customers and patrons that carry wireless devices such as smartphones, laptop computers, etc. may or may not avail themselves of this wireless network access. However, many wireless devices nonetheless are configured to actively scan for wireless access points, even while the wireless device is in a sleep state or state in which the graphical display is off or dimmed.

Recently, attempts have been made to provide mobile smartphone applications that are executed on the smartphones of patrons, and which provide information about a public accommodation, such as a menu or catalog. These smartphone applications suffer from the drawback that they generally only offer static information presented by a cloud-based website. As a result, even with the advent of such smartphone applications, they have not improved the customer experience much at all, and little improvement has been made on reducing in-store queues and order fulfillment.

### SUMMARY

A computing system includes an on-premises server system and on-premises wireless access point (WAP) providing wireless local area network (WLAN) coverage to the physical premises of a store. The computing system obtains an identifier of a wireless device included in wireless communications received from a wireless device via the on-premises WAP over the WLAN. The computing system identifies a target customer profile from among customer profiles stored at a database based on the identifier of the wireless device associated with the target customer profile. The computing system determines an in-store message that identifies a recommended on-sale item that is selected based on the target customer profile. The in-store message is sent to the wireless device that identifies the recommended on-sale item and includes a selector that enables the customer to purchase the item using the customer's financial information previously associated with the target customer profile.

This Summary describes only some of the concepts covered in greater detail in the following Detailed Description and associated drawings. As such, claimed subject matter, now or later presented, is not limited to the contents of this Summary.

### BRIEF DESCRIPTION OF DRAWINGS

FIG. 1 is a schematic diagram depicting an example computing system that facilitates interaction between a customer and a public accommodation.

FIG. 2 is a schematic diagram depicting an example computing system that is a non-limiting example of the computing system of FIG. 1.

FIG. 3A is a front perspective view of an example stand for a point of sale display device of the computing system of FIG. 2.

FIG. 3B is a side view of two of the example stands of FIG. 3A.

FIG. 4 is a schematic diagram depicting an example computing system that is another non-limiting example of the computing system of FIG. 1.

FIG. 5 is a schematic diagram depicting an example computing system that is another non-limiting example of the computing system of FIG. 1.

FIG. 6 is a schematic diagram depicting an example computing system that is another non-limiting example of the computing system of FIG. 1.

FIG. 7 is a schematic diagram depicting additional aspects of an example on-premises server system.

FIG. 8 is a schematic diagram depicting an example process flow for detecting presence of a customer at or nearby a public accommodation and identifying that customer.

FIG. 9 is a schematic diagram depicting an example process flow for determining the identity of a customer present at a POS device of a public accommodation.

FIGS. 10A, 10B, and 10C are schematic diagrams depicting aspects of employee-side and customer-side ordering graphical user interfaces.

FIG. 11 is a flow diagram depicting an example restaurant order input method.

FIG. 12 is a schematic diagram depicting example interactions between a customer-side ordering GUI, a content selection module, and a database system.

FIG. 13 is a schematic diagram depicting an example process flow for selecting content for a customer GUI and an employee GUI.

FIGS. 14 and 15 are flow diagrams depicting an example method for detecting a wireless device, and retrieving a customer profile and/or assets for the wireless device from either a local on-premises database or a remote database.

FIG. 16 is a flow diagram depicting an example method for sharing customer profile information among or between multiple premises.

FIG. 17 is a flow diagram depicting an example method for facilitating simplified ordering by a customer detected as being present at a store.

FIG. 18 is a schematic diagram depicting an example interaction between a customer's wireless device, an on-premises server system, and a service personnel display device.

FIG. 19 is a schematic diagram depicting an example computing device.

### DETAILED DESCRIPTION

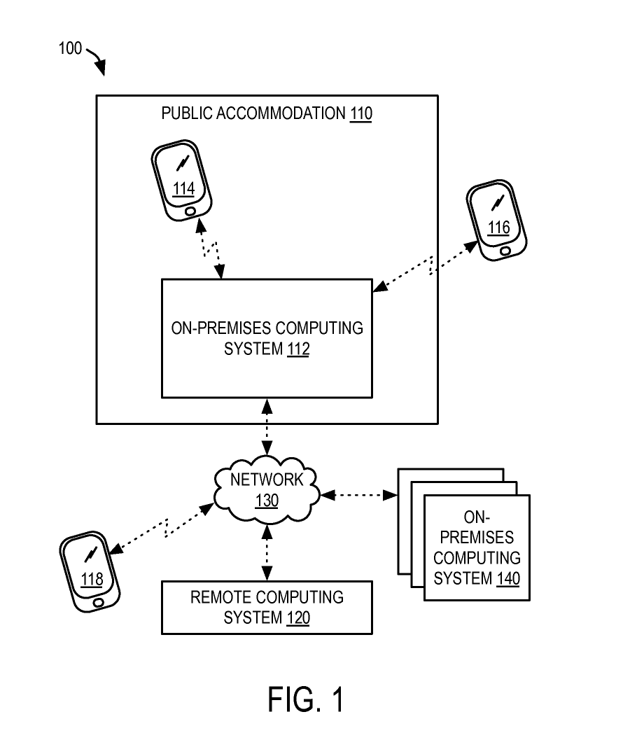

FIG. 1 is a schematic diagram depicting an example computing system 100 serving one or more public accommodations, such as example public accommodation 110. Computing system 100 includes an on-premises computing system 112 located on-premises of public accommodation 110. Computing system 100 further includes a remote computing system 120 located off-premises of public accommodation 110. On-premises computing system 112 and remote computing system 120 communicate with each other over communications network 130.

Wireless devices carried by customers, such as wireless devices 114, 116, 118, etc., when located in the vicinity of public accommodation 110 and within wireless communication range of on-premises computing system 112, may each communicate with computing system 100 via on-premises computing system 112 over a wireless communications link of a wireless local area network (WLAN) established by on-premises computing system 112. For example, wireless device 114 is depicted in FIG. 1 located on-premises of public accommodation 110 and wireless device 116 is depicted in FIG. 1 located nearby public accommodation 110, each within wireless communication range of on-premises computing system 112.

Alternatively or additionally, wireless devices carried by customers may communicate with computing system 100 via remote computing system 120 via a wireless communications link of a wireless wide area network that bypasses local computing system 112. Wireless device 118 is depicted in FIG. 1 to be remotely located from public accommodation 110 and outside of the wireless communication range of on-premises system 112. Wireless device 118 communicates over a wireless communication link with remote computing system 120 and/or local computing system 112 via a wide area network component of communications network 130.

Wireless devices carried by customers within WLAN range of on premises computing system 112 of public accommodation 110 may, at times, form part of local computing system 112. As an example, a customer's wireless device may present a graphical user interface (GUI) by which the customer may interact with the public accommodation to place an order, change an order, pay for a product or service, communicate with an employee of the public accommodation, etc. Computing system 100 may include one or more additional on-premises computing systems, such as on-premises system 140, each located on-premises of a different public accommodation.

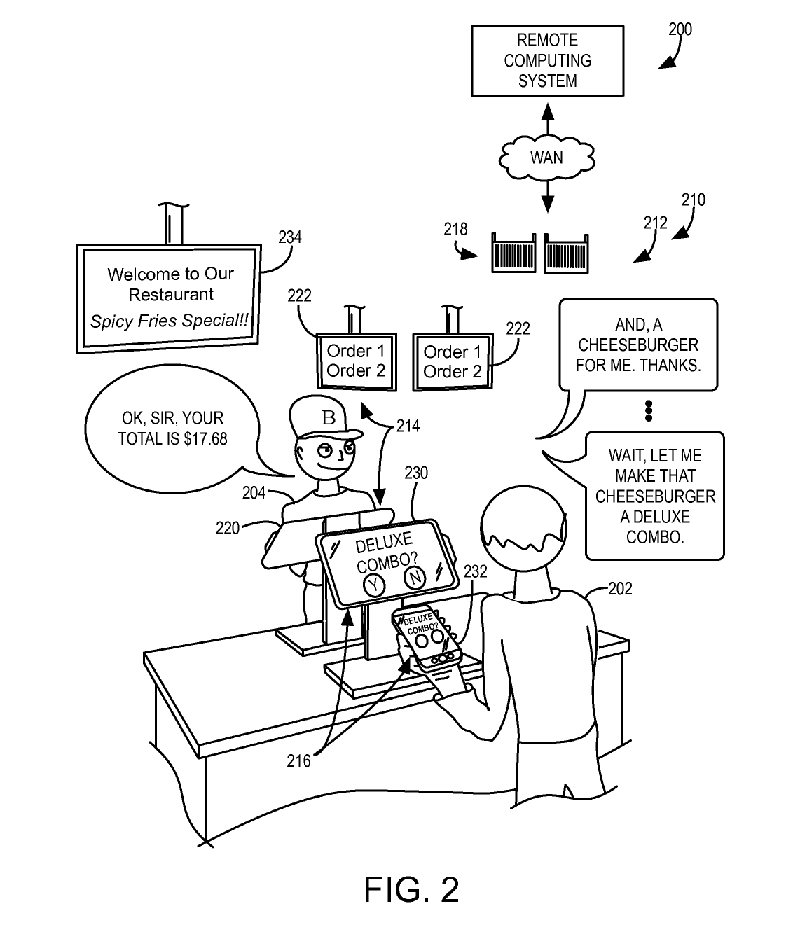

FIG. 2 is a schematic diagram depicting an example of computing system 200 serving a public accommodation 210. Computing system 200 is a non-limiting example of computing system 100 of FIG. 1. In this particular example, public accommodation 210 is a restaurant. However, a public accommodation may take other suitable forms, including a non-restaurant establishment, store, airport, train station, stadium, theater, park, amusement park, museum, etc. In FIG. 2, system 200 facilitates interaction between a customer 202 and public accommodation 210. In other contexts, a customer may instead refer to a patron, invitee, visitor, etc. depending on the type of public accommodation.

Computing system 200 includes an on-premises computing system 212 as a non-limiting example of on-premises computing system 112 of FIG. 1. On-premises computing system 212 includes a plurality of employee display devices, 214, a plurality of customer display devices 216, and one or more on-premises computing devices 218 (e.g., one or more server devices). Each of employee display devices 214 and customer display devices 216 communicate with the one or more on-premises computing devices 218.

Various types of employee display devices 214 may be provided, including a point-of-sale (POS) employee-facing display device 220 and/or service station (SS) employee-facing display devices 222. SS employee-facing display devices 222 may take the form of a kitchen display device, for example. Various types of customer display devices 216 may be provided, including a POS customer-facing display device 230, a display device 232 integrated with a customer's wireless device that is carried by e.g., customer 202, and/or a common display device 234 (e.g., an overhead display device).

These various display devices may be either stand-alone display devices (e.g., such as common display device 234) or physically integrated into a computing device (e.g., such as display device 232 of a customer's wireless device). Typically, interactive display devices that enable a user to provide a user input via that display device (e.g., a touch-sensitive display device) are integrated with a computing device, whereas non-interactive display devices that do not enable a user to provide a user input via that display device may be physically separate from a computing device.

As will become apparent from the following description, computing system 200 enables a proprietor, owner, or operator of public accommodation 210 to interact with customer 202 of the public accommodation while the customer is on-premises or even if the customer is off-premises (e.g., via display device 232 of the customer's wireless device). Typically, on-premises communications between a customer's wireless device and computing system 200 will be via a WLAN provided by on-premises computing system 212 when the customer's wireless device is within wireless communication range of the WLAN. However, when the customer's wireless device is outside of the wireless communication range of the WLAN, communication may be over a wide area network component, such as via the WAN depicted in FIG. 2, for example.

FIG. 2, depicts a service counter of a restaurant (the public accommodation in this example). A pair of display devices may be provided upon or in the vicinity of the service counter and at the point-of-sale. In an example, this pair of display devices includes POS employee-facing display device 220 and POS customer-facing display device 230. Devices 220 and 230 are typically positioned facing in opposite or opposing directions, angled to face upwards and/or towards a respective viewer, and positioned at a height that allows eye contact between an employee 204 and the customer over or otherwise beyond or around the display devices. However, other suitable arrangements or configurations may be used for employee-facing and customer-facing display devices.

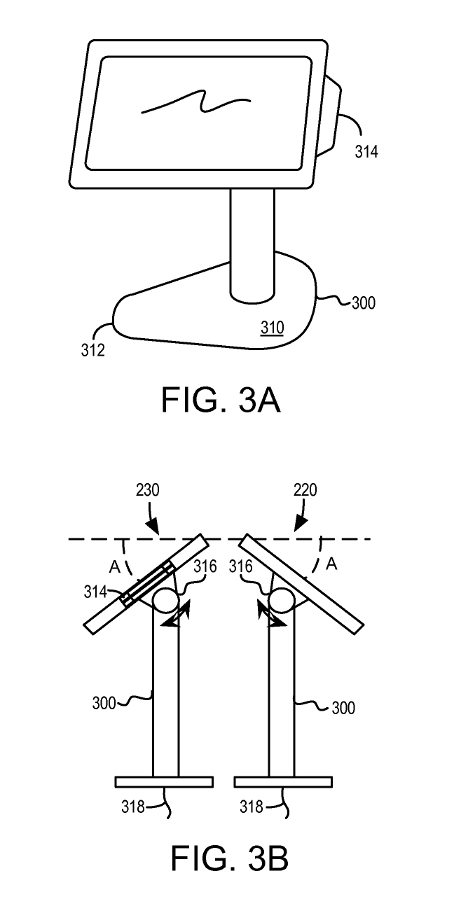

FIGS. 3A and 3B depict an example embodiment of a display stand 300 used for display devices 220, 230 of FIG. 2. As shown in FIG. 3A, the display stand includes an oblong base 310 that tapers toward a distal end 312. A card reader 314 is integrated into each display device, and configured to read payment cards, loyalty cards, etc. As shown in FIG. 3B, an angle adjustment mechanism 316 is provided to enable a user to adjust the angle of each display device. The angle may be adjusted, for example, in a broad range from an angle A of 0 degrees (i.e., horizontal) to 90 degrees (i.e., vertical), or in a narrower range from an angle A of 10 degrees declined from horizontal to 45 degrees declined from horizontal. This selective adjustability enables a user to position each display at a viewing angle that avoids reflections from light sources in the environment. Cables 318 providing power and/or a wired communications link to each display are typically routed through the frame associated with each display device.

Returning to FIG. 2, SS employee-facing display devices 222 are typically mounted on stands or support structures, which may include support poles, bars, or mounting frames extending downward from a ceiling of the public accommodation, outward from a wall or counter of the public accommodation, or upward from a counter or floor of the public accommodation. Common display device 234 is typically mounted to a ceiling, wall, floor, or fixture of the public accommodation, also via a support structure such as a support pole, bar, or mounting frame. Overhead display devices are typically positioned over the POS region of the public accommodation and typically display information of interest to customers gathered at or within the public accommodation.

SS employee-facing display devices 222 typically display orders and/or individual order items, placed by one or more customers, to be processed by employees of the public accommodation. A physical switch, referred to as a bump bar, may be positioned in the vicinity of each of the SS employee display devices 222 for an employee to push or active to indicate that an order or an individual order item has been fulfilled by the employee. This indication has the effect of “bumping” the order or the individual order item off of a pending list. Instead of or in addition to a physical switch such as the bump bar, SS employee display devices 222 may take the form of touch-sensitive display devices. In this context, employee SS display devices 222 may display a touch-activated button or other suitable graphical element for employees to press when an order or an individual order item has been fulfilled. In an example, an order may include or may be divided into a plurality of order items, and each order item may be routed to an appropriate SS employee display device by the one or more on-premises computing devices for fulfillment by an appropriate employee. In this manner, burger orders may be routed to the burger bar, drink orders may be routed to the drink bar, and fry orders may be routed to the fryer, for example.

Communications between the one or more on-premises computing devices 218 and each of the various display devices (e.g., 214, 216, etc.) may be over a wireless communications link using any suitable wireless networking protocol, such as Wi-Fi (802.11), for example. However, communications between on-premises computing devices and each of the various display devices may additionally or alternatively be over a wired communications link.

One or more of the various display devices may be physically integrated with an on-premises client computing device of on-premises computing system 212. One or more of the on-premises client computing devices may take the form of a wireless computing device, such as a tablet computing device, computer integrated wireless display device, hand-held wireless communication device, or wireless mobile computing device, for example. However, an on-premises display device may take the form of a thin-client device with limited computing functionality or a pure display device.

At times, wireless computing devices can be plagued with the problem of dropping wireless network connections. Accordingly, in at least some implementations, a heartbeat protocol may be employed by one or more of the on-premises computing devices or the on-premises computing system to continuously maintain a wireless network connection with each display device or on-premises client computing device with which a display device is integrated. This heartbeat protocol may be used to reduce or eliminate the problem of wireless computing devices dropping wireless network connections. In an example, a heartbeat ping may be transmitted once between every 10 seconds and every 1 minute. The heartbeat protocol may be used in some implementations to monitor the latency of wireless client computing devices located at or nearby the public accommodation, including on-premises display devices and/or wireless devices carried by customers. If any wireless client computing device is found to be out-of-sync with a current state maintained at a local server system of the on-premises computing system, that wireless client computing device may request an update of some or all state information from the local server system, such as GUI display elements, for example.

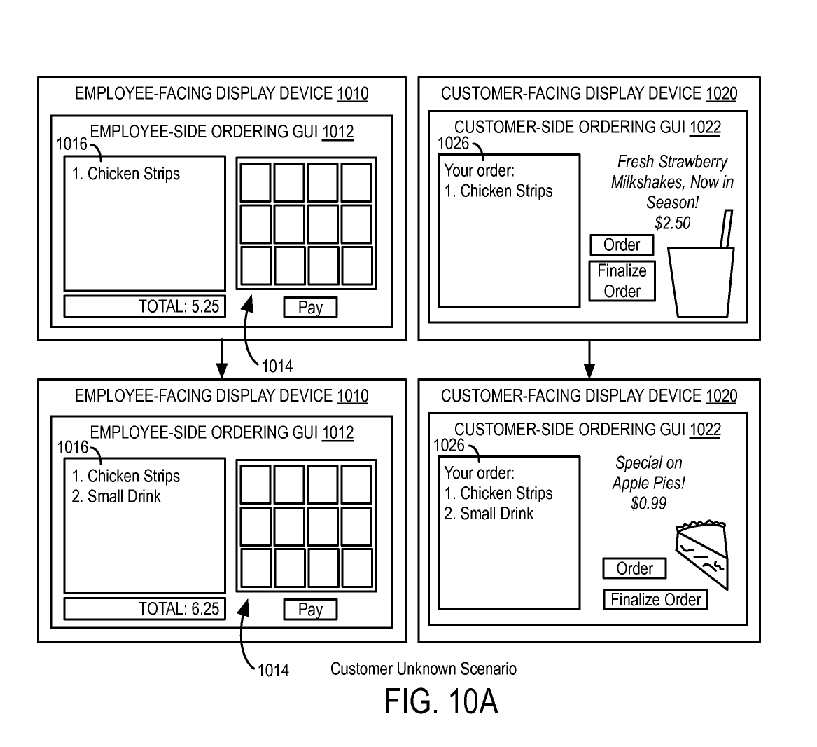

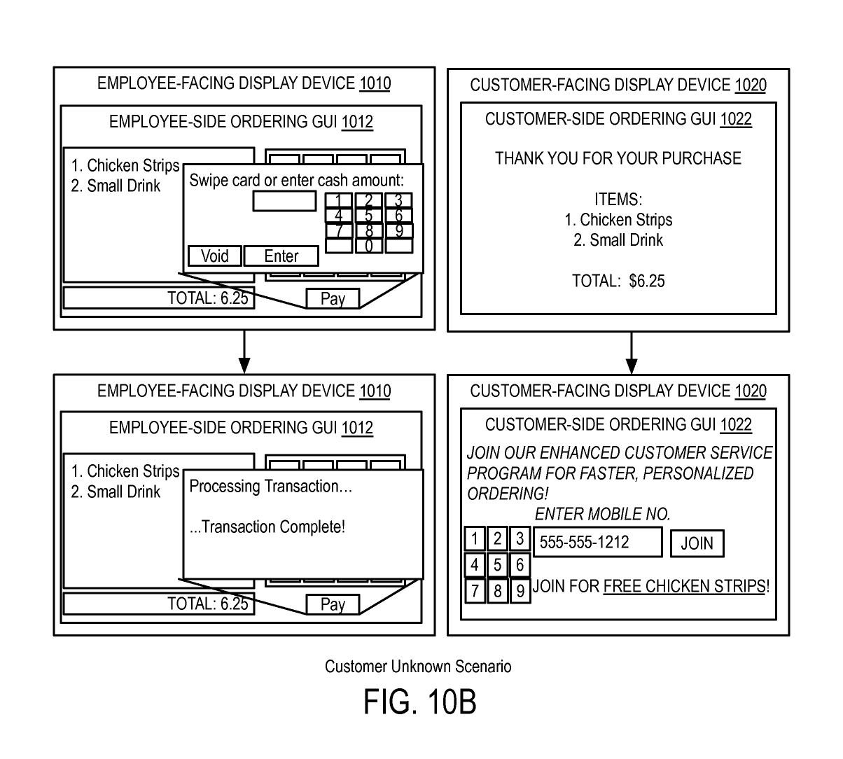

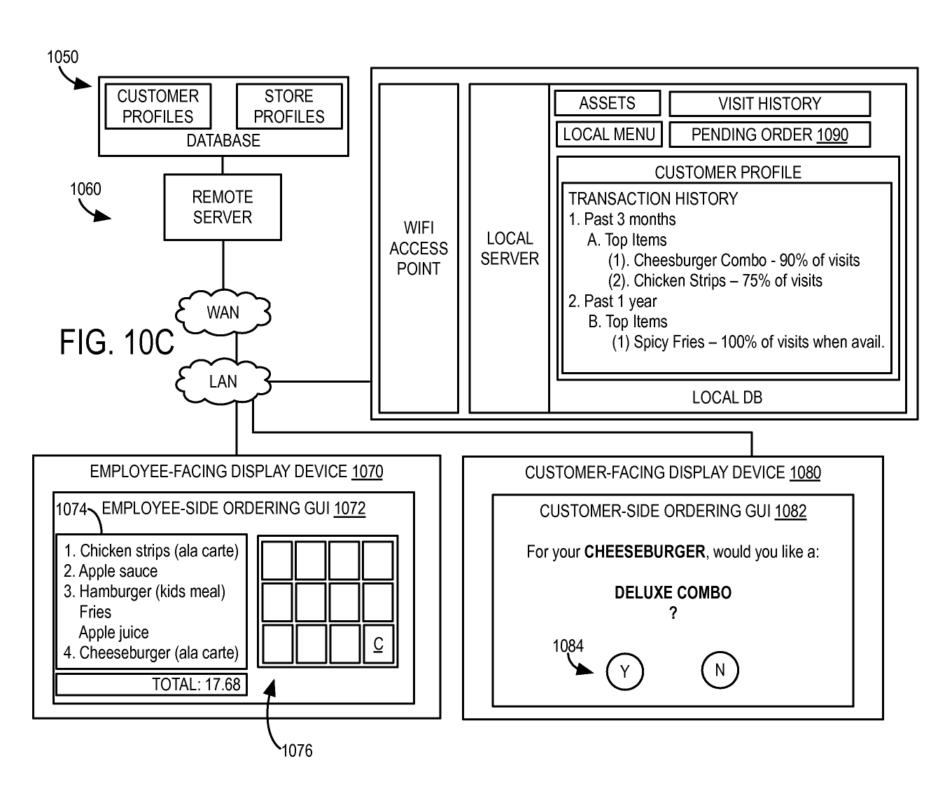

POS employee-facing display device 220 displays an employee-side ordering graphical user interface (GUI). An example of an employee-side ordering GUI is depicted in FIGS. 10A, 10B, and 10C. POS customer-facing display device 230 displays a customer-side ordering GUI. An example of a customer-side ordering GUI is depicted in FIGS. 10A, 10B, and 10C. As further depicted in FIG. 2, customer 202 is engaged in an order dialog with employee 204. As customer 202 speaks his or her order, employee 204 listens and operates or otherwise interacts with POS employee-facing display device 220 to input the order. As an example, POS employee-facing display device 220 is a touch-sensitive display device that receives touch-based user inputs from employee 204. These touch-based user inputs may be directed at the employee-side ordering GUI displayed by the POS employee-facing display device 220.

As employee 204 enters information specifying the order, content may be displayed on or by both POS employee-facing display device 220 and POS customer-facing display device 230. The content displayed at POS customer-facing display device 230 via a customer-side ordering GUI may include general content that is displayed to all customers and may additionally include custom content that is displayed to a particular customer (e.g., customer 202) based on a customer profile maintained by computing system 200 for that customer. The customer profile may be maintained at or by the one or more on-premises computing devices 218 and/or one or more remote computing devices of a remote computing system.

As an example, the content displayed on or by the POS customer-facing display device 230 may include a promotional offer for an item. As another example, the content may include a tally or listing of the order, which enables the customer to confirm the accuracy of the order and make any necessary or desired modifications. A highly tailored customer experience may be realized by displaying content to the customer that is based on a customer profile and/or a premises profile of the public accommodation. As an example, offers may be determined by computing system 200 to be related to items ordered by customer 202 based on a customer profile for that customer, and those related items can be promoted, while promotions for items that are out of inventory or currently unavailable at the public accommodation can be avoided or omitted.

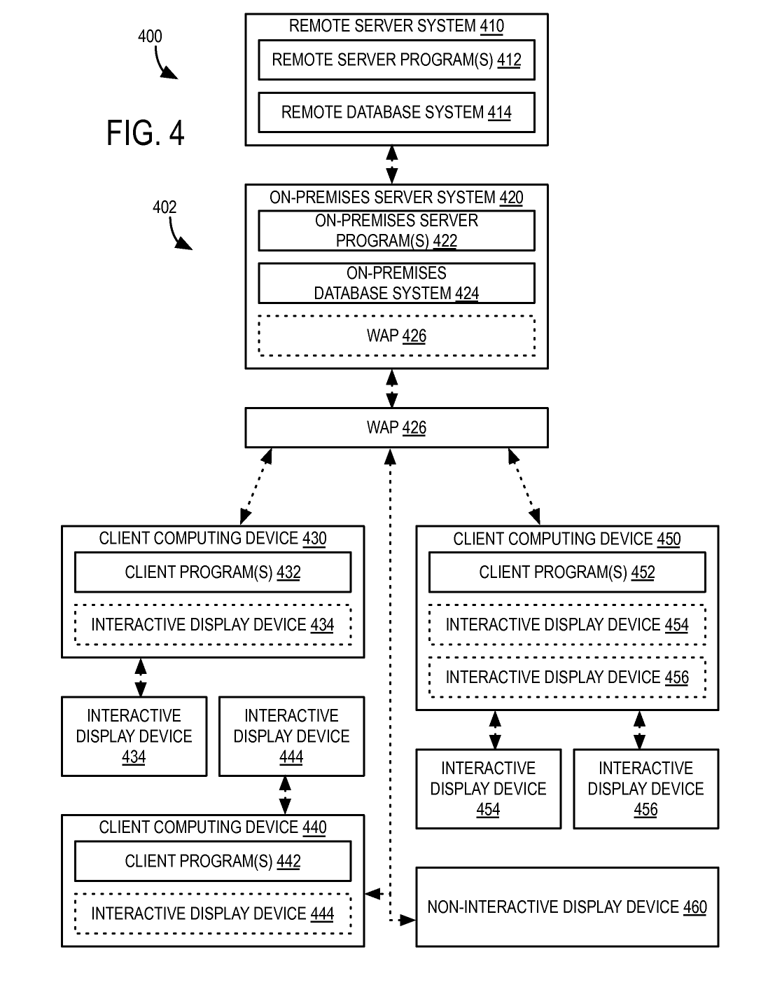

FIG. 4 is a schematic diagram depicting an example computing system 400. Computing system 400 of FIG. 4 is a non-limiting example of computing system 100 of FIG. 1. Computing system 400 includes a remote computing system in the form of a remote server system 410, and an on-premises computing system 402. On-premises computing system 402 includes an on-premises computing system in the form of on-premises computing system 420, and various client computing devices 430, 440, and 450. On-premises server system 420 and the various client computing devices are located on-premises of a public accommodation. Remote server system 410 is located at a geographically remote location from the public accommodation.

Remote server system 410 includes one or more remote server devices having one or more remote server programs 412 and a remote database system 414 having one or more databases. On-premises server system 420 includes one or more on-premises server devices having one or more on-premises server programs 422 and an on-premises database system 424 having one or more databases. Communications between remote server system 410 and on-premises server system 420 are via a wide area network (WAN).

A server program may include or take the form of an operating system or a portion thereof, an application program, firmware, etc. that, when implemented by one or more computing devices, provides server functionality. Server functionality may include one or more of a web server, a database server, a search server, a statistics server, a push notification server, a mirroring server, a DHCP server, a NTP server, etc. Each of these servers may be implemented as a respective server program or collection of server programs operated at a computing device or computing system.

WAP 426 may be integrated with and form part of an on-premises server device of on-premises server system 420. Alternatively, WAP 426 may be a standalone device that is physically separate from one or more of the on-premises server devices of on-premises server system 420. Communications between WAP 426 and on-premises server system 420 may be via wired or wireless communications link. WAP 426 provides a wireless local area network (WLAN) through which the various client computing devices communicate with on-premises server system 420. Alternatively or additionally, some client computing devices may communicate with on-premises server system 420 via a wired communications link, which may bypass WAP 426.

Client computing device 430 includes one or more client programs 432, and may include or be associated with an integrated or physically separate interactive display device 434, depending on implementation. Similarly, client computing device 440 includes one or more client programs 442 and may include or be associated with an integrated or physically separate interactive display device 444, depending on implementation. In an example, interactive display device 434 may refer to a POS employee-facing display device or a SS employee-facing display device, and interactive display device 444 may refer to a POS customer-facing display device. These interactive display devices may take the form of touch-sensitive display devices.

Client computing device 450 includes one or more client programs 452, and may include or be associated with two or more integrated or physically separate interactive display devices 454 and 456. In an example, interactive display device 454 may refer to a POS employee-facing display device, and interactive display device 456 may refer to a POS customer-facing display device. In this example, employee-facing and customer-facing display devices may be integrated with or associated with a common client computing device. Communications between a client computing device and a display device may be via a wired or wireless communication link, depending on implementation.

On-premises computing system 402 may further include a non-interactive display device 460. An example of a non-interactive display device 460 is the previously described common display device (e.g., overhead display device) that displays content, but does not necessarily receive user inputs. Communications between on-premises server system 420 and non-interactive display device 460 may be via a wired or wireless communications link, depending on implementation.

The various client programs depicted in FIG. 4 may be configured to receive messages from one or more server programs of on-premises server system 420 and/or remote server system 410, transmit messages to one or more server programs of on-premises server system 420 and/or remote server system 410, process information contained in such messages, process information stored locally at the client computing device, output graphical information in the form of a GUI displayed by the display device, and/or receive information in the form of user inputs provided by a user of the client computing device.

As an example, a client program may receive a user input via a GUI displayed at a touch-sensitive display device, may process information responsive to that user input, and/or transmit a message indicating the user input or information associated with that user input to a server program. Messages transmitted to a server program by a client program may include a request message, a post message, etc., among other messages associated with an API supported by the server program. Messages received from a server program by a client program may include a response message, a push notification message, etc., among other messages associated with the API supported by the server program.

A client program may include or take the form of an operating system or a portion thereof, an application program, firmware, or a combination thereof. In an example, a client program may include a general-purpose browser program (e.g., web browser or file browser). In another example, a client program may include a special-purpose application program that is specifically paired with and/or configured for communication with an on-premises server program of each on-premises computing system and/or with a remote server program of the remote computing system. As an example, a server program may be configured to send push notifications to a client program to be displayed to a user via a display device. Application programs, may be downloaded and/or purchased by customers from a website or an online application store.

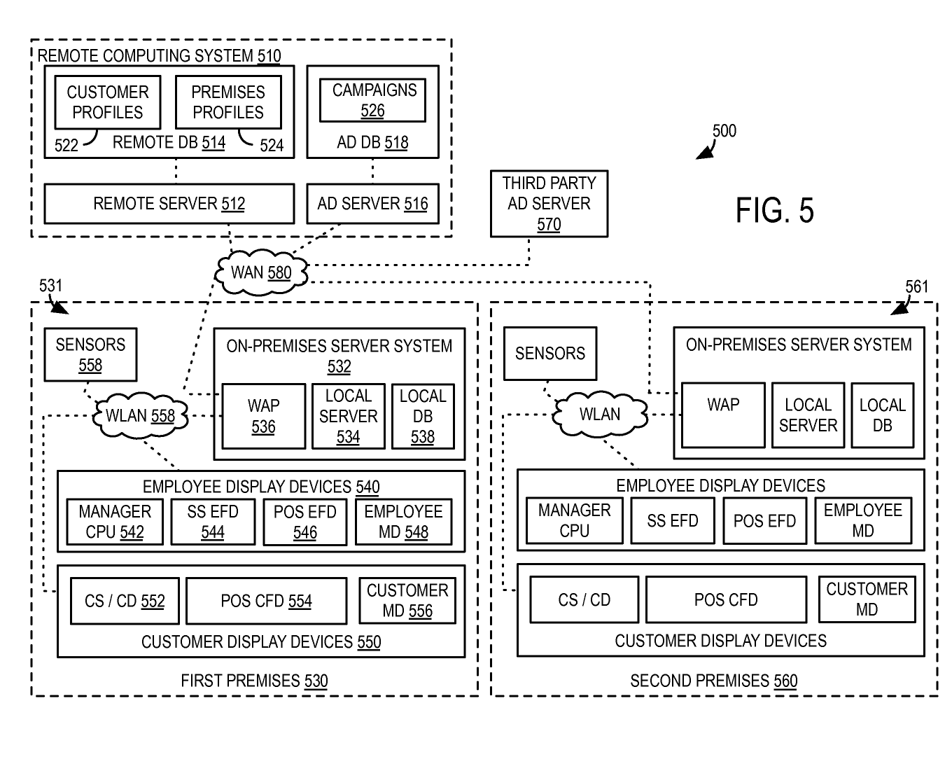

FIG. 5 is a schematic diagram depicting example software and hardware architecture of a computing system 500. Computing system 500 is a non-limiting example of system 100 of FIG. 1. Broadly speaking, computing system 500 includes a cloud component in the form of a remote computing system 510 and an on-premises component in the form of on-premises computing system 531. On-premises computing system 531 includes a local server system 532 including one or more local servers 534. A server system refers to one or more computing devices that implement one or more server programs to provide server functionality.

On-premises computing system 531 may further include a WAP 536, and a local database system 538 configured to store data including e.g., local versions of customer profiles and a premises profile of the public accommodation, among other forms of data. WAP 536 provides a wireless local area network (WLAN) 558 that covers at least a portion of first premises 530 of a public accommodation. Typically, the WAP is a Wi-Fi access point; however, other wireless protocols may be utilized. WAP 536, local servers 534 and local database system 538 may be housed in a single computing device 530, although separate computing devices may be instead configured to perform these functions. Further, when installed on-premises in a public accommodation, computing devices (containing WAP, servers, and database system) may be provided in pairs with failover functionality for redundancy.

A variety of sensors 558 of on-premises computing system 531 may be installed throughout premises 530 of the public accommodation that are configured to output sensor signals to local servers 534. Examples of such sensors include door count sensors, drive through lane car sensors, motion detection sensors, ambient temperature sensors, ambient light sensors, etc. Local servers 534 receive these sensor signals, processes the signals, and/or performs actions in response to the signals.

Local servers 534 are configured to communicate with each of the employee display devices 540 and each of the customer display devices 550 via WLAN 558 established by the WAP (or alternatively or additionally via wired communications links). While employee display devices and customer display devices are referred to generally as display devices, it will be appreciated that such display devices are typically integrated into tablet computing devices, that contain one or more processors, memory, client software, and communications hardware that enable the display device or integrated computing device to interact or otherwise communicate with the local server system 532.

A separate on-premises computing system may be provided in each of a plurality of public accommodations. For example, second premises 560 includes an on-premises computing system 561. The on-premises computing system of each public accommodation further communicates with a remote computing system 510 of computing system 500 over a communications network, such as a wide area network (WAN) (e.g., the Internet and/or cellular edge networks providing connectivity to the Internet), for example. Data from the on-premises computing system 531, 561, etc. at each public accommodation is synced at programmatic intervals to the data stored at remote computing system 510.

Remote server system 510 includes one or more remote servers, such as one or more remote servers 512 and one or more advertising servers 516. Remote servers 512 are configured to serve data to local servers 534, in each of the plurality of public accommodations in which local servers 534 are situated. For each customer of the computing system 500, a customer profile 522 may be created and maintained among or between remote and on-premises computing systems. A customer profile 522 may be created via a web portal, via the customer display devices 550 (including via a customer's wireless mobile device 548) or via other suitable display devices. The customer profile 522 stores or otherwise includes various data about the customer, as detailed below. The customer profile 522 is stored at the remote server system 510 within remote database system 514, and a local version of the customer profile 522 may also be stored in local database system 538 of on-premises computing system 531 of a particular local public accommodation with which the customer interacts. Typically, data from the local versions of the customer profile stored at local database system 538 is aggregated in the customer profile stored on remote database system 514, and accordingly this customer profile 522 may be referred to as an aggregated customer profile, since it contains data aggregated from a variety of sources/public accommodations (e.g., both first premises 530 and second premises 560).

Premises profiles 524 are also provided for each public accommodation, and are stored in remote database system 514. Premises profiles include catalog or menu information and employee information for timekeeping and scheduling software implemented by the employee displays devices 540. Catalog or menu information includes a plurality of menu items, with textual descriptors, image and/or video assets, price information, discount and/or promotion information, options information, etc., for each menu item. When the public accommodation is included in a chain of multiple public accommodations each having a different premises, the menu or catalog information for a particular public accommodation may be built upon a template for the chain, and premises-specific menu items may be included, for example.

Remote computing system 510 may also include an ad server system 516 configured to serve advertisements to customers through customer display devices 550, based upon information in the customer profiles and/or premises profiles. It will be appreciated that the term advertisements here is meant to encompass self promotions, i.e., discounts for the public accommodation's own goods or services. In addition, a third party advertising server system 570 is provided for cross-promotion opportunities. The proprietor of a public accommodation may provide cross-promotional advertisement placement opportunities on customer-facing display devices during various customer interactions. These placement opportunities may be fulfilled by ads served from third party ad server system 570.

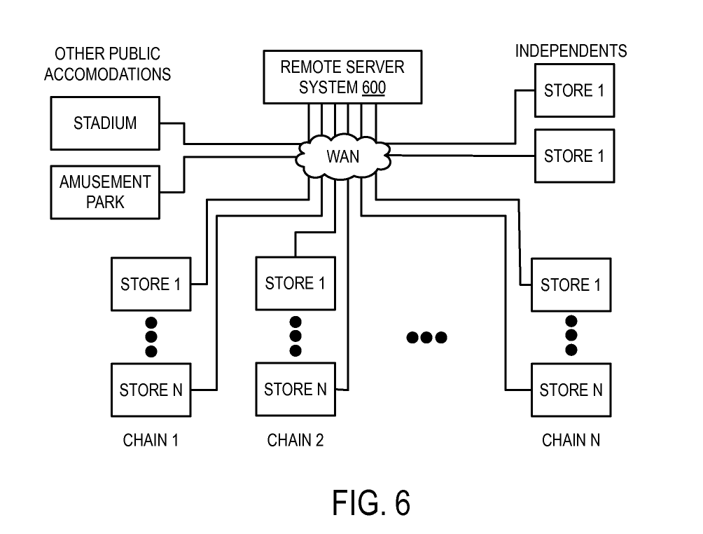

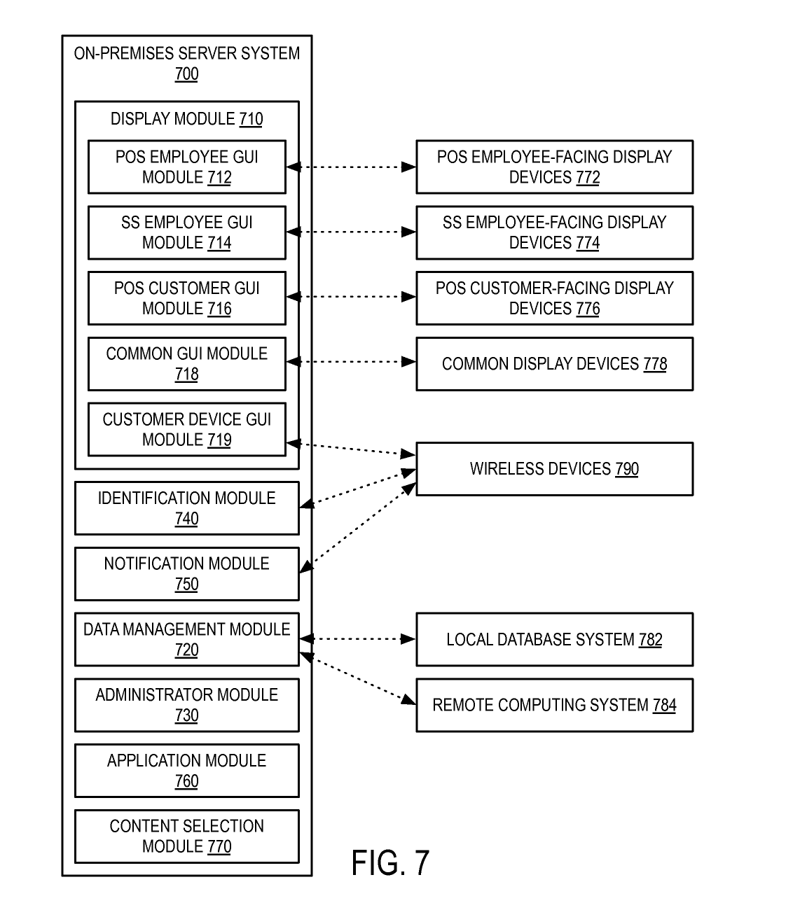

As shown in FIG. 6, a remote computing system in the form of a remote server system 600 may be configured to communicate (e.g., via a wide area network (WAN)) with not only on-premises computing systems in or of a plurality of public accommodations (e.g., stores) from a single chain, but additionally with on-premises computing systems in or of a plurality of stores from a plurality of chains. Further, the remote server system may be configured to communicate with on-premises computing systems from independent stores, stadiums, amusement parks, and other public accommodations. The customer's profile is updated (at remote server system 600 and/or at each individual on-premises computing system) based on that customer's activity in the public accommodation visited in each of the chain stores, independent stores, stadium, amusement park, or other location. In some implementations, an on-premises database system of a particular on-premises computing system may include customer profiles only for those customers that have visited that particular premises, while the remote computing system may maintain a complete set of customer profiles for all customers across all premises.

FIG. 7 is a schematic diagram depicting additional aspects of an example on-premises server system 700. On-premises server system 700 may include one or more on-premises server devices. In the example depicted in FIG. 7, on-premises server system 700 includes the following modules: a display module 710 to manage input and output of the various display devices of the on-premises system, a data management module 720 to manage data between or among a local database system 782 and a remote computing system 784, an administrator module 730 to manage administrator control of the on-premises server system, an identification module 740 to manage customer identification and detection of customers' wireless devices 790, a notification module 750 to manage the delivery of notifications to customers e.g., at the customers' wireless devices 790, an application module 760 to manage application programs implemented by the on-premises server system (e.g., server programs or other applications operated at the server system), and a content selection module to select content for display at GUIs of the various display devices.

FIG. 7 depicts display module 710 including various modules that correspond to the various display devices, including: a POS employee GUI module 712 to manage input and output of one or more POS employee-facing display devices 772, an SS employee GUI module 714 to manage input and output of one or more SS employee-facing GUI display devices 774, a POS customer GUI module 716 to manage input and output of one or more POS customer-facing display devices 776, a common GUI module 718 to manage input and output of one or more common display devices 778, and a customer device GUI module 719 to manage input and output of one or more customers' wireless devices 790.

Each module of on-premises server system 700 may receive information, optionally process that information, and output the processed information for use by another module, device, system, etc. As an example, user inputs received via a display device by a sub-module of display module 710 may be used by another sub-module of display module 710, by application module 760, by administrator module 730, by data management module 720, by identification module 740, etc. Each module of on-premises server system 700 may include or take the form of software implemented by a computing device.

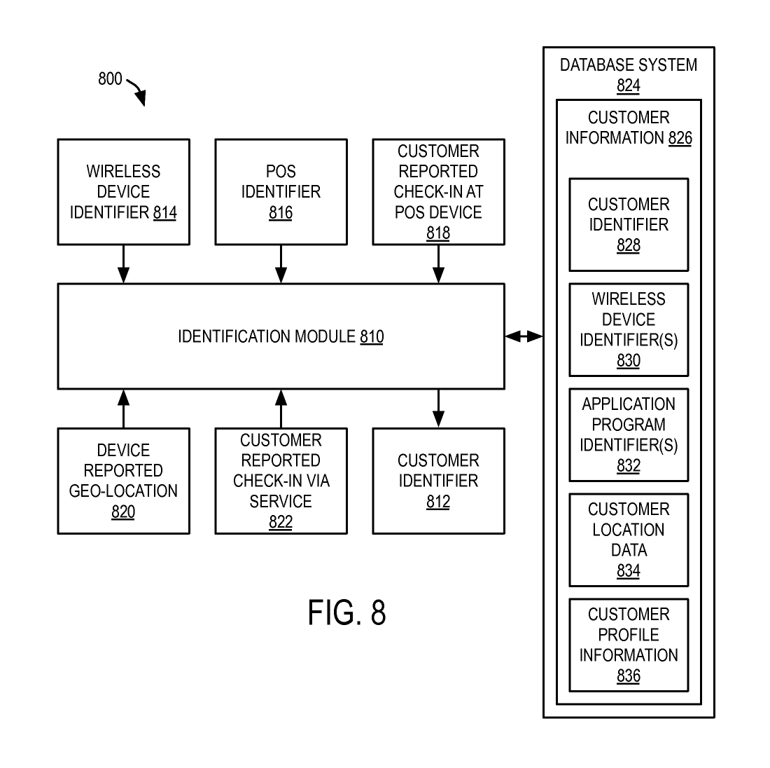

FIG. 8 is a schematic diagram depicting an example process flow 800 for detecting presence of a customer at or nearby a public accommodation and identifying that customer. In FIG. 8, an identification module 810 receives various information inputs and outputs an indication of a customer's presence at the public accommodation along with a customer identifier that identifies the customer. Identification module 810 may form part of a server program operating at an on-premises computing system or part of a server program operating at a remote computing system. Identification module 810 is a non-limiting example of previously described identification module 740 of FIG. 7.

The various information inputs provided to and received by identification module 810 may include a wireless device identifier 814 (e.g., a Wi-Fi MAC address or token) of a wireless device carried by the customer, a POS device identifier 816 (e.g., a GUID of an iBeacon or other Bluetooth technology) for a POS device of the public accommodation that is proximate the wireless device carried by the customer, a customer reported check-in 818 via a POS device of the public accommodation, device reported geographic location information 820 as reported by the wireless device carried by the customer via a network service, a customer-reported check-in 822 via a network service, and other data accessible at database system 824.

Database system 824 may include customer information 826 for each customer. Non-limiting examples of customer information 826 include a customer identifier 828 for the customer, one or more wireless device identifiers 830 of the customer, one or more application program identifiers 832 of application programs installed at the one or more wireless devices of the customer, customer location data 834 indicating a past or current location of the customer (e.g., location may be indicated by geographic coordinates, a public accommodation identifier at which the customer is located, a POS device identifier at which the customer is proximate, etc.), and other customer profile information 836.

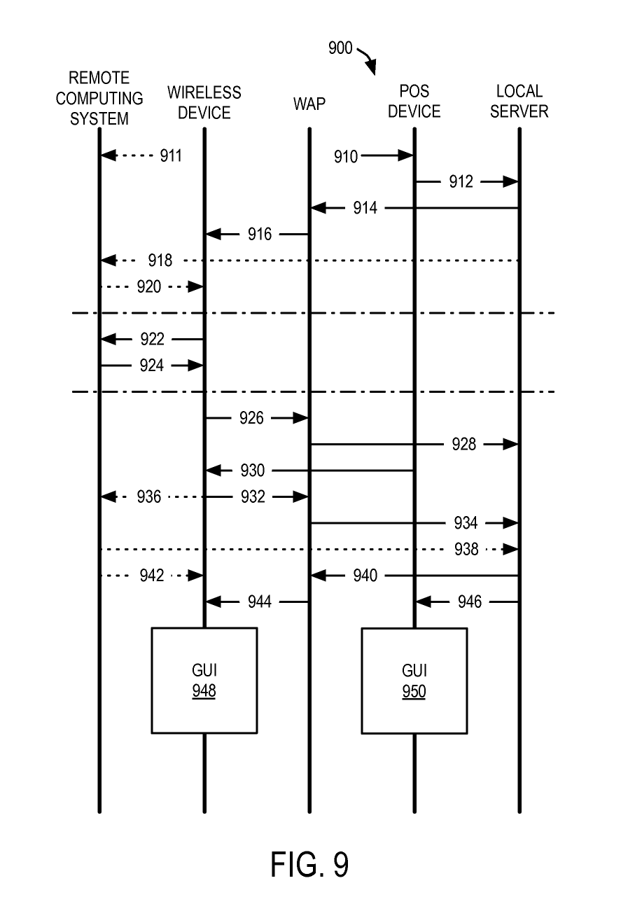

Wireless device identifier 814 may be received by identifier module 810 transmitted by a wireless device of a customer via a WAP of a public accommodation over a wireless local area network. An example of wireless device identifier 814 is a MAC address or token communicated in a wireless beacon frame transmitted by the wireless device. An example of this process is described in further detail with reference to FIG. 9. Identifier module 810 may utilize wireless device identifier 814 to identify a customer profile of a customer associated with the wireless device identifier at database system 824.

POS identifier 816 may be transmitted by a POS device of a public accommodation, where the POS identifier may be received by a wireless device carried by the customer. The wireless device may transmit the POS identifier received from the POS device to the identifier module. The POS identifier may be used by the identifier module to detect that a customer of the wireless device is proximate the POS device in the public accommodation. An example of this process is also described in further detail with reference to FIG. 9.

An example of a customer reported check-in 818 via a POS device (or other suitable kiosk) of the public accommodation may include a customer entering his or her customer identifier or information associated with the customer identifier in database system 824. Identifier module 810 may use the customer reported check-in via a POS to determine that the customer is proximate the POS and the identity of that customer.

A customer reported check-in 822 via a service may include a customer indicating via a client program of the customer's wireless device that the customer is located at a particular public accommodation. As one example, the service may take the form of a social networking service that receives a check-in message from the wireless device and outputs that check-in message along with the customer's identity to subscribing computing systems, such as a computing system at which identifier module 810 operates. Identifier module 810 may use the customer reported check-in via a service to determine that the customer is at or nearby a particular public accommodation and the identity of the customer.

An example of device reported geographic location information 820 may include a wireless device carried by the customer transmitting an indication of the geographic location of the wireless device to a service. The service may in turn communicate that geographic location of the wireless device along with the customer's identity to subscribing computing systems, such as a computing system at which identifier module 810 operates. Identifier module 810 may use the geographic location information to determine that the customer is at or nearby a particular public accommodation and the identity of the customer.

FIG. 9 is a schematic diagram depicting an example process flow 900 for determining the identity of a customer present at a POS device (or other suitable kiosk) of a public accommodation. At 910, a customer initiates a registration process by supplying a contact address to a POS device of a public accommodation. In one example, the contact address includes a telephone number of the customer's wireless device. Alternatively or additionally, the contact address includes an email address of the customer.

At 912, a client program operating at the POS device communicates the contact address received from the customer to a local server of the public accommodation. Communications indicated at 912 may be via the WAP over the wireless LAN in some examples, or may be via a wired communications link in other examples. The local server communicates a message to the contact address. The message contains a link that may be traversed to a network resource from which a client application may be downloaded by the customer to the customer's wireless device. In one example, the local server communicates the message to a WAP of the public accommodation at 914, which in turn communicates the message to a wireless device of the customer at 916 via a wireless LAN provided by the WAP. In another example, the local server communicates the contact address to a remote computing system via a wide area network at 918. Alternatively, at 911, the customer initiates the registration process by supplying contact address to the remote computing system via a website hosted, for example, at the remote computing system. In this example, the remote computing system communicates a message to the contact address at 920. For example, the remote computing system communicates the message to the wireless device of the customer via a wireless component (e.g., cellular network) of a wide area network or alternatively via a wireless LAN provided by a WAP (which could include the WAP of the public accommodation).

At 922, the customer traverses the link contained in the message received at 916 or 920 to a network resource from which an application program may be downloaded to the customer's wireless device. In the example depicted in FIG. 9, the network resource is hosted at the remote computing system. However, in other examples, the network resource may take the form of an application program store hosted by a third-party provider. At 924, the application program is downloaded and installed by the customer onto the customer's wireless device. Installation and/or download of the application program may include a registration process by the customer by which the customer provides customer-specific information to the remote computing system, such as the customer's name, contact address, financial information, biographical information, etc. In an example, the customer inputs the customer-specific information via a customer registration interface displayed at the wireless device or via another computing device operated by the customer.

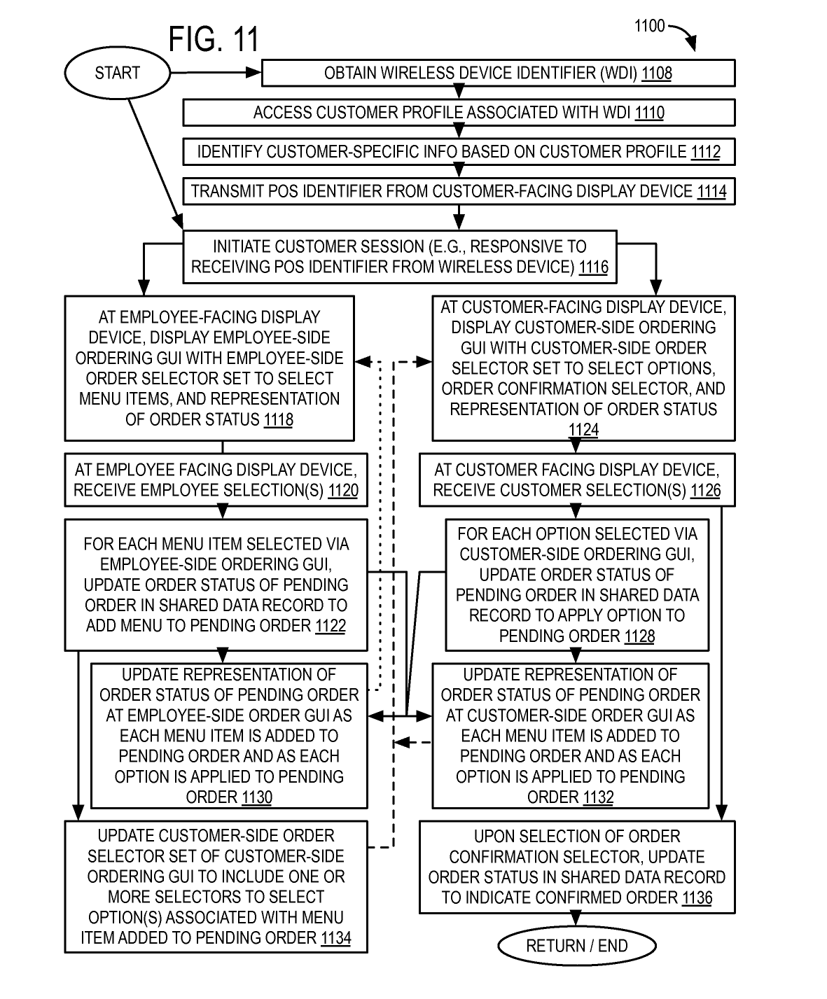

After installing the application program onto the wireless device, the customer carries the wireless device into a public accommodation served by the remote computing system and including a local server, a POS device, and a WAP. The public accommodation may be the same public accommodation through which the customer previously interacted at 910, 916, etc., or may be a different public accommodation. At 926, the wireless device transmits one or more wireless beacon frames that are received by the WAP of the public accommodation via a wireless LAN provided by the WAP. As a non-limiting example, the one or more wireless beacon frames may be transmitted by the wireless device via a Wi-Fi wireless communications protocol over the wireless LAN. These beacon frames may, for example, contain a wireless device identifier (WDI) in the form of a MAC address, token, or other suitable identifier. This process will be described in further detail with reference to FIG. 11.

The WAP or the local server in combination with the WAP extracts an identifier of the wireless device from the wireless beacon frame. At 928, the local server receives the identifier of the wireless device, and retrieves a customer profile associated with the identifier of the wireless device. Processes 926 and 928 may be used to provide coarse detection of the customer within or nearby the public accommodation, but does not necessarily indicate that the customer is presently located at or nearby a particular POS device of the public accommodation. For example, the customer may be in a queue of customer waiting to place an order and/or the public accommodation may include multiple POS devices through which a customer's order may be placed.

As the customer approaches a POS device of the public accommodation, a client program operating at the POS device wirelessly transmits a POS identifier of the POS device via a wireless personal area network or wireless near-field communications that is received by the wireless device at 930. As a non-limiting example, the POS identifier may take the form of a GUID of an iBeacon and/or Bluetooth communications protocol (or other suitable identifier such as an SSID, MAC address or token), and may be transmitted in one or more wireless beacon frames for reception and extraction by the wireless device. This process will be described in further detail with reference to FIG. 11, for example.

The POS device may take the form of a POS customer-facing display device that displays a POS customer-side GUI (e.g., an ordering GUI or other suitable GUI), a POS employee-facing display device that displays an employee-side GUI (e.g., an ordering GUI or other suitable GUI), or other suitable on-premises kiosk. The client program operating on the wireless device transmits or initiates transmission of the identifier of the POS device to either the remote computing system over a wireless WAN as indicated at 936, or transmits the identifier of the POS device to the local server via the WAP over a wireless LAN as indicated at 932 and 934. In the example where the identifier of the POS is transmitted to the remote computing system at 936, the remote computing system reports to the local server at 938 that the wireless device is located at or nearby the POS device indicated by the identifier of the POS device. In either example, the local server receives an indication that the wireless device is located at or nearby the POS device indicated by the identifier of the POS device at either 934 or 938. Processes 930, 932, 934 and/or processes 936 and 938 may be used to provide finer or more proximate detection of the customer within or nearby a particular POS device of the public accommodation.

The local server transmits customer-side GUI information that at least partially or wholly defines a customer-side GUI to the wireless device via the WAP over the wireless LAN as indicated at 940 and 944. Alternatively or additionally, the remote server system transmits customer-side GUI information that at least partially or wholly defines a customer-side GUI to the wireless device over a wireless WAN as indicated at 942. The client program of the wireless device receives and displays a customer-side GUI 948 based on the customer-side GUI information received at 942 and/or 944. At 946, the local server transmits customer-side GUI information that at least partially or wholly defines a customer-side GUI to the POS device indicated by the identifier of the POS device received at 934 and/or 938. Communications indicated at 940 may be via the WAP over the wireless LAN in some examples, or may be via a wired communications link in other examples. A client program of the POS device receives and displays a customer-side GUI 950 based on the customer-side GUI information received at 946.

FIGS. 10A and 10B depict an example onboarding process that may be performed by a computing system. The left hand side of FIG. 10A illustrates an employee-facing display device 1010 displaying an example employee-side ordering GUI 1012, while the right hand side of FIG. 10A illustrates an example customer-side ordering GUI 1020 displayed on a customer-facing display device 1022. In this example, the left and right hand GUIs are displayed at the same time or substantially contemporaneously with each other.

Beginning at top left, as a customer whose identity is unknown to the computing system approaches the point of sale, the employee (e.g., service counter employee) inquires as to the customer's order and begins entering the order in the employee-side ordering GUI, by pressing graphical order buttons 1014. Graphical order buttons 1014 are an example of selectors that form an employee-side selector set. Initially, the customer orders chicken strips, and the employee selects an order button of order buttons 1014 associated with chicken strips, and accordingly an indication of the order “chicken strips” appears in the pending order items list 1016 in employee-side ordering GUI 1012. The state of the pending order is transmitted to the local server system of the premises, which then communicates the state of the order to the customer-facing display device 1020 and/or to a remote computing system. Accordingly, ordered items of the pending order are listed in pending order items list 1026 on customer-side ordering GUI 1022. The reverse process may be performed for customer selections displayed at the employee-side ordering GUI.

Additionally, the pending order items list may be transmitted to other employee-facing display devices (e.g., SS employee-facing display devices) for display to service personnel responsible for preparing the order, even before the pending order has been finalized or completed. In this manner, service personnel may begin preparing the order prior to the customer completing the order or paying for the order, thereby providing faster service to the customer.

At this point in the process, the client program of the customer-facing display device that displays the customer-side ordering GUI 1022 may request a promotion from the local server system of the premises, based on the pending order state. In response, the local server system of the premises is configured to select a promotion (or other option to be made available to the customer) for display to the customer or to request a promotion for display from a remote computing system. Alternatively, the local server system may send a push message to the client program of the customer-facing display device to update the promotion responsive to a change in a state of the pending order. In the depicted example the promotion is for strawberry milkshakes, which are displayed to all customers who haven't yet ordered a drink. This promotion is an example of an order-specific option that is based on a current state of the pending order.

At a next stage, the customer orders a small drink, which is also reflected in the pending order list 1026 and 1016 of each GUI. The employee-facing display device 1010 communicates this order item to the local server system of the premises, which in turn transmits updated pending order list information to the customer-facing display device. Since a beverage is now in the pending order, according to promotion logic then in effect, the promotion for Strawberry Milkshakes ceases to be displayed, and a new promotion for apple pie is displayed on the customer-facing display device 1020.

FIG. 10A further depicts an example of a selector for the customer that enables the customer to finalize or complete the pending order. Upon selection of the Finalize Order button in FIG. 10A, the pending order is updated to reflect a finalized order by the local server system and/or at a remote computing system.

Turning now to the top left of FIG. 10B, once the order is complete, the employee may select “PAY” and cause a payment interface to appear. The employee is prompted to swipe a payment card of the customer, or enter a cash amount manually and then press enter, for example. Alternatively, the customer may be prompted to swipe a payment card of the customer, or enter a cash amount manually, and then press enter via the customer-facing GUI. In at least some implementations, if the customer is detected or identified (such as wirelessly using e.g., iBeacon as described with reference to FIG. 8 or 9, or by entering a customer identifier and/or login credentials such as a phone number and a pin or biometric input) the POS display device (e.g., on-premises device or the customer's wireless device) will prompt the user to simply use a stored payment credential, which could be a credit or debit card, link to bank account, or gift card or stored value card, or a linked crypto-currency, as non-limiting examples. Hence, the customer does not have to present a payment method in his implementation, but may instead just a stored payment solution.

Once payment is received, a transaction summary screen is displayed to the customer with a summary of the order and total amount paid. After the payment transaction completes, an onboarding interface is displayed to the customer, as illustrated at the bottom right of FIG. 10B. The onboarding interface requests the customer to input a mobile telephone number (or email address) to enroll in the computer system, along with an enticement of a free item (e.g., the most expensive item) from the customer's most recent order. If the user opts in and inputs the mobile telephone number, the customer is presented with an electronic coupon or physical coupon for the item.

Once the mobile telephone number is input, the a link is sent to the user via SMS message (at the contact address provided by the mobile phone number or alternatively an email address). In one example, the link points to a resource served by the local server system. The customer may select the link to complete the enrollment process. When the user selects the link, the mobile computing device sends a request for the resource to the local server system, which in turn reads the MAC address (e.g., medium access control address) and/or token of the user's mobile computing device. By identifying this MAC address and/or token, and storing one or more of these identifiers along with the a contact address of the customer (e.g., the mobile telephone number or email address) in the customer's profile, the computing system can wirelessly detect the user's presence through iBeacons and/or Wi-Fi signals sent from the wireless device to the WAP of the local server system of each public accommodation.

As shown in FIG. 10C, once a customer has been enrolled in computing system 1050, and opted in to wireless device recognition, the user's presence in a public accommodation is automatically detected by computing system 1050. Computing system 1050 includes an employee-facing display device 1070 configured to display an employee-side ordering GUI 1072 with an employee-side order selector set 1076 for selecting menu items available on a menu of a restaurant or other type of public accommodation. Computing system 1050 further includes a customer-facing display device 1080 configured to display a customer-side ordering GUI 1082 with a customer-side order selector set 1084 for selecting options associated with menu items that have been added to the pending order as indicated at 1074. Display devices 1070 and 1080 may take the form of POS display devices, for example.

Selection of either the employee-side order selector set or the customer-side order selector set causes an order status of a pending order to be updated in a shared data record (e.g., as pending order 1090) associated with both the employee-facing display device and the customer-facing display device at the local database system. In the particular scenario illustrated in FIG. 10C, the customer-side order selector set 1084 enables a user to select Y (YES) or N (NO) to the offer to make (e.g., upgrade in this context) the menu item Cheeseburger that appears in the pending order list 1074 (and/or at a pending order list presented at the customer GUI), into a Cheeseburger Deluxe Combo. Thus, the offer itself was generated by computing system 1050 based upon the content of the pending order. Selection of order selector set 1084 by the customer will result in a message being transmitted from a client program of the customer-facing display device to the local server system, which in turn causes the shared data record (e.g., pending order 1090) in the local database system to be updated.

Upon updating of the pending order 1090 in the shared data record, the local server of the on-premises computing system transmits an update message to employee-facing display device 1070 that causes a client program to update the pending order list 1074 to reflect the customer's selection. This update message may be provided by the local server as a push notification message or as a response to a periodic refresh request transmitted by the client program of the employee-facing display device. The same approach may be utilized by the client program of the client-facing display device responsive to employee submissions or selections, for example. Hence, in this example, the local server transmits messages to a display device responsive to an order placed via another display device. In another example, selection of a combo button “C” among employee-side order selector set 1076, causes a message to be transmitted by the client program of the employee-facing display device to the local server requesting that a selected item (e.g., the Cheeseburger) in the pending items list 1074 be made into a combo option.

FIG. 11 is a flow diagram depicting an example restaurant order input method 1100. Method 1100 may be performed, in at least some implementations, to identify customer-specific recommendations and initiate a customer session involving dual, paired customer-side and employee-side GUIs. Method 1100 enables an employee and a customer to interact with each other to construct a pending order that includes one or more menu items and one or more options associated with those menu items.

Method 1100 or portions thereof may be performed by an on-premises computing system (e.g., including an on-premises or local server component thereof) physically located on-premises of a public accommodation that is visited by a user (e.g., a customer) carrying a mobile wireless device. In some implementations, aspects of method 1100 may be performed by and distributed across the on-premises computing system and a remote computing system communicating with each other via a communications network.

At 1108, the method includes obtaining a wireless device identifier (WDI) from a first set of one or more wireless beacon frames transmitted by a wireless device (i.e., a mobile wireless device or mobile device) carried by a customer. As a non-limiting example, the wireless device may be detected via a wireless access point of a wireless local area wireless network of the on-premises computing system that covers at least a portion of the premises.

The WID may take the form of a MAC address, token, or other suitable identifier that is present in the first set of one or more beacon frames transmitted by the wireless device using, for example, a Wi-Fi protocol. The WID enables multiple wireless devices of a device ecosystem to be distinguished from each other by the on-premises computing system. In at least some implementations, a wireless access point of the on-premises computing system may obtain or otherwise extract the MAC address, token, or other suitable identifier from the first set of beacon frames, and send the MAC address, token, or other suitable identifier to the on-premises server or server system.

Within at least some wireless networks (e.g., Wi-Fi/802.11), beacon frames are periodically transmitted by each wireless device to announce the presence of that wireless device. Beacon frames typically include a media access control (MAC) header, a frame body, and FCS. The MAC header contains the media access control (MAC) address. Each wireless device is uniquely identified by a respective MAC address. A beacon interval is the time between beacon frame transmissions by the wireless device. The beacon interval is expressed in terms of a Time Unit (TU), which is a configurable parameter. Typically the beacon interval is configured at 100 TU, however, other suitable values may be used.

Throughout this disclosure, the term MAC address is used as an example of an identifier. In each case, a token may take the place of the MAC address or may be used in addition to the MAC address to identify a device within a wireless network. This token may take the form of an anonymized token. An anonymized token in beacon frames or iBeacon may be used prior to a wireless device establishing a connection with the wireless access point. Here, the token may be used in place of the MAC address so that the MAC address is not initially broadcast by the wireless device. The token is transmitted by the wireless device, and during establishment of the wireless connection, the MAC address is subsequently transmitted as the identifier. Thus, two identifiers, a token and a MAC addressed may be used in at least some implementations. The identifiers described herein may take the form of unique identifiers (e.g., globally unique identifiers or GUIDs) that are unique or substantially unique within a particular domain to enable devices to be distinguished from each other.

In some implementations, validation may be applied to confirm that a target wireless device associated with a target MAC address (and/or token) is present at the public accommodation by matching an on-premises characteristic of the detected beacon frames. The on-premise characteristic may include one or more of (1) a signal strength of the beacon frames that attains or is greater than a predetermined signal strength threshold, (2) a plurality of successive beacon frames from the same MAC address or other suitable identifier being detected over a period of time that attains or is greater than a predetermined time threshold, (3) a plurality of beacon frames from the same MAC address or other suitable identifier being detected as having a substantially constant signal strength value (or attaining or exceeding a signal strength threshold) over at least a predetermined time threshold, or (4) other suitable set of filters or rules to determine whether the wireless device exhibited merely a transitory presence within the wireless network range of the wireless access point (e.g., carried by a passenger of a vehicle or a pedestrian passing through or near the area). It will be appreciated that the above filters rules may be configurable by a system administrator either globally or at an individual public accommodation to provide suitable validation responsiveness.

At 1110, the method includes accessing a customer profile associated with the WID. The customer profile may be accessed from a local on-premises database system of the on-premises computing system, or from a remote database system of a remote computing system. A database system may include a plurality of customer profiles, each associated with a respective customer identifier. Each customer identifier may be the same as or based on the WID, or may be associated with the WID in the database system by way of a different customer identifier. In some implementations, a customer identifier may differ from the WID, and may take the form of a e.g., a username, email address, randomly generated unique identifier, or other suitable identifier that is associated with the WID. Upon detection and identification of the WID, a customer profile associated with the WID (e.g., directly or via an associated customer identifier) may be accessed. The method at 1110 may further include accessing additional information stored at the database system. Such additional information may include a premises profile for the public accommodation and/or an asset database that contains promotional items, recommended items, advertisements, etc. for the public accommodation.

At 1112, the method includes identifying customer-specific information (e.g., one or more options, recommendations, promotional items, messages, etc.) based on the customer profile. In one example, customer-specific recommendations may be identified by the on-premises computing system. In another example, the customer-specific information may be identified by a remote computing system, and may be transmitted to the on-premises computing system where the customer-specific information may be utilized to provide a tailored user experience for the identified customer.

At 1114, the method includes transmitting a POS identifier from each customer-facing display device via a second set of one or more wireless beacon frames for reception by wireless devices carried by customers visiting the public accommodation. As an example, the POS identifier may be transmitted over a Bluetooth protocol (e.g., Bluetooth Low Energy (BLE) technology) or other suitable short range wireless communication protocol to identify or validate that a particular customer is nearby a particular customer-facing display device. The POS identifier may take the form of a GUID of the iBeacon protocol, as a non-limiting example. A client program operating at the wireless device may extract or otherwise obtain the POS identifier from the second set of one or more wireless beacon frames.

At 1116, the method includes initiating a customer session at the on-premises computing system. For example, the customer session may be initiated at the customer-facing display device indicated by the POS identifier to display a customer-side ordering GUI containing customer-specific information for the customer and/or at a paired employee-facing display device for the employee serving that customer responsive to receiving the POS identifier from the wireless device. In other examples, one or more of operations 1108, 110, 1112, and/or 1114 may be omitted, such as if the customer manually signs/logs into his or her customer profile or customer account via a customer-facing display device of the public accommodation to manually indicate the customer's presence.

In the context of a restaurant premises, a customer session typically includes a multi-phase process. As a non-limiting example, a customer session includes (1) construction of a pending order, (2) confirmation of the pending order, and (3) fulfillment of the confirmed order by the employees of the public accommodation. The remaining process flow of method 1100 includes example operations associated with the construction and confirmation phases of the customer session. In at least some implementations, upon initiating the customer session, a customer-side ordering GUI may be generated that includes customer-specific information based on the customer's profile information and/or an employee-side ordering GUI may be generated that includes the customer-specific information.

At 1118, the method includes, at an employee-facing display device of the on-premises computing system, displaying an employee-side ordering GUI that includes an employee-side order selector set. The employee-side order selector set may include one or more selectors for an employee to input one or more employee selections to select menu items of a restaurant menu to be added to a pending order. A non-limiting example of an employee-side order selector set is depicted in FIGS. 10A and 10C. The employee-side ordering GUI may additionally include customer-specific information that enables the employee to engage the customer and/or provide better service to the customer. Such customer-specific information may include the customer's name, a photograph, a favorite or most ordered menu item, a favorite seating location at the public accommodation, customer-specific recommendations, customer-specific promotional items, etc.

At 1124, the method includes, at the customer-facing display device of the on-premises computing system, displaying a customer-side ordering graphical user interface (GUI) that includes a customer-side order selector set. The customer-side order selector set may include one or more selectors for a customer to input one or more customer selections to select options associated with menu items added to the pending order. A non-limiting example of a customer-side order selector set is depicted in FIGS. 10A and 10C. The customer-side ordering GUI may additionally include customer-specific information such as the customer's name, a photograph, a favorite or most ordered menu item, customer-specific recommendations, customer-specific promotional items, etc.

In at least some implementations, the customer-side order selector set includes a subset of the employee-side order selector set having fewer than all of the selectors of the employee-side order selector set. Employee selections may influence the selectors that are available for selection and/or displayed to the customer via the customer-facing display device. As one example, the customer-side order selector set may include one or more selectors to select options for one or more of the menu items of the restaurant menu that have been selected via the employee-side order selector set. As another example, the customer-side order selector set may include one or more selectors to select customer recommendations, promotions, special offers, sale items, etc. that may be generated by the on-premises computing system (and/or a remote computing system) responsive to and based upon the customer's profile and/or selections already made by the employee and/or the customer in the current pending order. For example, the customer-side order selector set may further include one or more customer-specific recommendations identified at 1114. The customer-side order selector set may further include an order confirmation selector, which upon selection by the customer causes the order to be confirmed and processes by the employees of the public accommodation.

The display of customer-side ordering GUI may be performed in parallel with the display of employee-side ordering GUI such that each GUI is presented to a respective customer and employee at the same time or substantially the same time. In at least some implementations, a customer-side order selector set may not be displayed or otherwise presented via the customer-facing display device until one or more menu items have been added to the pending order. One or more additional selectors of a customer-side order selector set may be added to the customer-side ordering GUI as menu items are added to the pending order. In this implementation, the customer-side order selector set is dependent upon menu items added to the pending order. This concept will be described in further detail with reference to operation 1134. However, in other implementations, the customer-side ordering GUI may include an initial customer-specific recommendation or promotion that may be replaced or updated in response to one or more menu items being added to the pending order.

At 1120, the method includes, at the employee-facing display device, receiving one or more user inputs in the form of one or more selections made by the employee via the employee-side order selector set. As one example, a customer may verbally communicate an order for a menu item to an employee, which in turn the employee may select that menu item by directing one or more user inputs at the one or more selectors of the employee-side order selector set to add that menu item to the pending order. In an example, the employee-facing display device is a touch-sensitive display device that enables the employee to touch one or more graphical items (e.g., buttons) of the GUI that correspond to the employee-side order selector set.

At 1122, the method includes, for each menu item selected via the employee-side ordering GUI (e.g., at 1120) to be added to the pending order, updating an order status of the pending order in a shared data record to add that menu item to the pending order. The shared data record may reside at an on-premises database of the on-premises computing system and/or at a remote database of a remote computing system that is accessible to the on-premises computing system via a communications network. The shared data record may refer to one or more data fields of a database system that is shared among or between the employee-facing display device and the customer-facing display device. In at least some implementations, the on-premises computing system (and/or the remote computing system) may establish a link between a particular employee-facing display device and a particular customer-facing display device upon initiating the customer session at 1116 with which the shared data record for the pending order is associated.

At 1134, for at least one menu item added to the pending order updated in the shared data record (or for each or every menu item added to the pending order, or for each or every menu item added to the pending order that is associated with at least one option in a database of the on-premises computing system), updating the customer-side order selector set of the customer-side ordering GUI to include one or more selectors for the customer to select one or more options associated with the at least one menu item (or each or every menu item added to the pending order, or for each or every menu item added to the pending order that is associated with at least one option) to be applied to the pending order.

In an example, the one or more options may include an item augmenting option selectable by the customer to augment a parameter of a corresponding target menu item (e.g., the at least one menu item added to the pending order) in the shared data record. A parameter of a menu item may include a quality, quantity, size, shape, color, or other attribute of that menu item. As a non-limiting example, an item augmenting option for a beverage may include a beverage flavor, a beverage size, a beverage garnish type, etc. As another non-limiting example, an item augmenting option for a sandwich may include a type of topping or whether that type of topping is to be included, a type of bread, a type of meat, a size of the sandwich, etc.

In another example, the one or more options may include an order augmenting option selectable by the customer to add a promotional menu item or a recommended menu item to the pending order in the shared data record. The promotional menu item or the recommended menu item (including selection and display thereof) may be based, at least in part, on the corresponding target menu item (e.g., at least one menu item added to the pending order) in the shared data record. Although closely related, a recommended menu item may be distinguished from a promotional menu item in a number ways. A promotional menu item may refer to a time-based or campaign-driven advertisement, whereas a recommended menu item may be a common or natural companion item to another menu item added to the pending order. Depending on the particular campaign parameters, selection and display of a promotional menu item may be triggered responsive to a particular menu item being added to the pending order. Similarly, recommended menu items may be selected and displayed responsive to a particular menu item being added to the pending order.

In some scenarios, an option may include or otherwise take the form of both an item augmenting option and an order augmenting option. As a non-limiting example, an option may include both an increase or decrease in size of a menu item added to the pending order (e.g., an upgrade from a small hamburger to a large hamburger) and the addition of another menu item (e.g., a beverage) to the pending order. For example, FIG. 10C depicts a scenario in which a cheeseburger is upgraded to a deluxe combo, which may refer to both an item augmenting option and an order augmenting option.

At least some of the options presented via the customer-side order selector set may be order-specific (e.g., general to all customers based on the current pending order) and at least some of the options may be profile-specific (e.g., based upon the customer's profile information). While both order-specific and profile-specific options may be considered to be customer-specific, order-specific options are based on a current state of the customer's pending order whereas profile-specific options are based on the customer's profile information beyond the current state of the customer's pending order. Additionally, order-specific options do not necessarily rely on detection of the customer's identity via a wireless device identifier, whereas profile-specific options rely on detection of the customer's identity.

For example, a customer (regardless of other forms of profile information) may order a main course food menu item and be presented with an option to include a beverage at a reduced upcharge relative to the normal cost of the beverage. In this case, the order-specific option is dependent upon the current pending order for that particular customer, but is not necessarily dependent upon the customer's other profile information beyond that current pending order. Profile-specific options are based upon customer profile information beyond the current pending order, which may include historic information detailing past orders for that customer (in the same public accommodation and/or in other public accommodations), expressly defined customer preferences, the customer's biographical information, etc. Hence, profile-specific options rely on identification of the customer, such as via wireless detection of a wireless device identifier. A customer-specific option may include or take the form of both a profile-specific option and an order specific option. For example, an option may be presented to the customer only after a particular menu item is added to the pending order and only if the customer's profile information satisfies an additional criteria.

At 1126, the method includes, at the customer-facing display device, receiving one or more user inputs in the form of one or more selections made by the customer via the customer-side order selector set. In one example, a selection made by the customer may include selection of an option to be applied to the pending order. In another example, a selection made by the customer may include selection of the order confirmation selector to initiate an order confirmation by the customer as described in further detail with reference to operation 1122. As an example, the customer-facing display device may be a touch-sensitive display device, and the customer may select one or more graphical elements (e.g., buttons) that correspond to the selectors of the selector set. In some examples customer selections at 1126 and employee selections 1120 may be received contemporaneously with each other or in parallel during a customer session. For example, a customer may select options associated with a first menu item added to the pending order by the employee while the employee is adding a second menu item to the pending order.

At 1128, for each option selected via the customer-side ordering GUI to be applied to the pending order, the method includes updating the order status of the pending order in the shared data record to apply that option to the pending order. One or each of the customer-side ordering GUI and/or the employee-side ordering GUI may include a representation of the order status of the pending order updated in the shared data record. For example, the representation of the order status of the pending order may include or otherwise indicate each menu item added to the pending order and/or each option applied to the pending order. Selection of an option may add a new menu item to the pending order, remove a menu item from the pending order, and/or change a parameter of a menu item of the pending order.

At 1130, the method includes updating the representation of the order status of the pending order at the employee-side ordering GUI as each menu item is added to the pending order and/or as each option is applied to the pending order. This representation may take the form of a pending order list, such as previously described with reference to pending order list 1024 of FIG. 10. At 1132, the method includes updating the representation of the order status of the pending order at the customer-side ordering GUI as each menu item is added to the pending order and/or as each option is applied to the pending order. In some examples, operations 1130 and 1132 may be performed in parallel with each other such that customer and employee GUIs are contemporaneously updated to reflect selections made by both the employee and the customer.

Updates may be initiated by a client program residing at each display device, by the on-premises computing system, or by the remote computing system. For a display device that receives a user input, the client program may update the GUI responsive to that user input, and may transmit information indicating that user input to the on-premises computing system, to the remote computing system, and/or to another display device. For a display device that is updated responsive to a user input received via another display device, a client program of the display device may periodically request updates from the on-premises computing system, the remote computing system, of that other display device. Alternatively or additionally, push notifications may be transmitted by the on-premises computing system, the remote computing system, of that other display device to the client program. In either case, the client program receives an indication of an update and/or update information, and updates the GUI accordingly.

One or each of the employee-side ordering GUI and/or the customer-side ordering GUI may include an order confirmation selector. For example, an order confirmation selector may be generated for display at the customer-facing display device to confirm selection by the customer. The order confirmation selector may be generated responsive to one or more employee selections received at 1120 to enable customer to confirm selections made by the employee. The order confirmation selector may be additionally or alternatively generated responsive to one or more customer selections received at 1126. The pending order may be confirmed responsive to selection of the order confirmation selector. At 1136, the method includes, upon selection of the order confirmation selector by the customer via the customer-side ordering GUI or by the employee via the employee-side ordering GUI, updating the order status of the pending order in the shared data record to indicate a confirmed order.

The approach of method 1100 of FIG. 11 recognizes that customer/employee interaction remains an important component of the customer experience at a public accommodation, and that employees are typically more familiar with the menu or offerings of a public accommodation than customers. Yet, customers remain effective at confirming the accuracy of a pending order, and customers, proprietors and third-party advertisers are benefited by the ability to deliver targeted promotions or recommended items at the point of sale for selection by the customer. By limiting the customer-side selectors to a subset of the employee-side selectors, the customer may be focused on selecting options that are associated with menu items added to the current pending order by the employee.

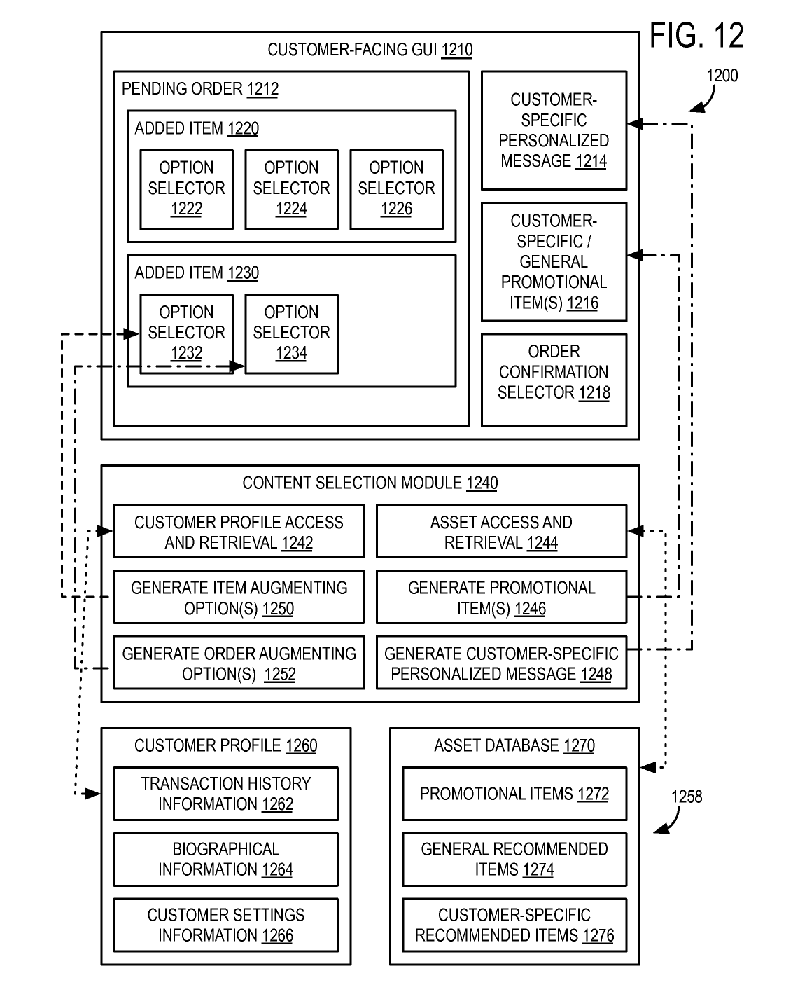

FIG. 12 is a schematic diagram 1200 depicting example interactions between a customer-side ordering GUI 1210, a content selection module 1240, and a database system 1258. Module 1240 may refer to previously described 770 of FIG. 7, for example. A non-limiting example of a customer-side ordering GUI is depicted in FIG. 12 as customer-side ordering GUI 1210. GUI 1210 includes one or more of a representation of a pending order 1212 (e.g., a pending order list), a customer-specific personalized message 1214, one or more customer-specific promotional items and/or one or more general promotional items 1216, and/or an order confirmation selector 1218.

Items added to the pending order may be included in the representation of the pending order. For example, added item 1220 and added item 1230 are displayed or otherwise presented via GUI 1210 in graphical form. Various options are associated with each added item. For example, added item 1220 may include one or more option selectors 1222, 1224, 1226, etc. associated with added item 1220. Added item 1230 may include one or more option selectors 1232, 1234, etc. associated with added item 1230. Such options may be specific to and dependent upon the identity of the added item (i.e., order-specific). Additionally, options may be specific to the customer and the customer's profile information beyond the current state of the pending order (i.e., profile-specific).

Various selectors of GUI 1210 collectively form a selector set. In the example depicted in FIG. 12, the selector set includes option selectors 1222, 1224, 1226, 1232, and 1234, one or more selectors associated with customer-specific and/or general promotional items 1216, and an order confirmation selector 1218.

It will be understood that GUI 1210 is depicted in FIG. 12 at a particular instance in time along an order input timeline. For example, the pending order depicted in FIG. 12 includes two added items, 1220 and 1230, which may have been by an employee.

Database system 1258 includes one or more customer profiles, such as example customer profile 1260. Database system 1258 further includes an asset database 1270 that contains one or more promotional items 1272, general recommended items 1274, and/or customer-specific recommended items 1276. Module 1240 performs customer profile access and retrieval at 1242. For example, module 1240 accesses and retrieves transaction history information 1262, biographical information 1264, and/or customer settings information 1266 from customer profile 1260.

Content selection module 1240 generates a customer-specific personalized message at 1248 based on information accessed and retrieved from customer profile 1260 at 1242. The customer-specific personalized message generated at 1248 may be displayed or otherwise presented to the customer via GUI 1210 in graphical form as customer-specific personalized message 1214. As a non-limiting example, the customer-specific personalized message may include “Welcome [CUSTOMER-NAME]”, in which the [CUSTOMER-NAME] field includes the name of the customer accessed and retrieved from biographical information 1264.

Module 1240 performs asset access and retrieval at 1244. For example, module 1240 accesses and retrieves promotional items 1272, general recommended items 1274, and/or customer-specific recommended items 1276 from asset database 1270. Module 1240 generates one or more promotional items at 1246 based on information accessed and retrieved from asset database 1270 and/or customer profile 1260. The one or more promotional items generated at 1246 may be displayed or otherwise presented to the customer via GUI 1210 in graphical form as one or more customer-specific promotional items and/or one or more general promotional items 1216.

Module 1240 generates one or more item augmenting options at 1250 that, if selected by the customer, augments a parameter of an item previously added to the pending order. The one or more item augmenting options may be displayed or otherwise presented to the customer via GUI 1210 in graphical form as or in association with corresponding option selectors, such as example option selector 1232.

Module 1240 generates one or more order augmenting options at 1252 that, if selected by the customer, augments the order by adding or removing a menu item from the pending order. The one or more order augmenting options may be displayed or otherwise presented to the customer via GUI 1210 in graphical form as or in association with corresponding option selectors, such as example option selector 1234.

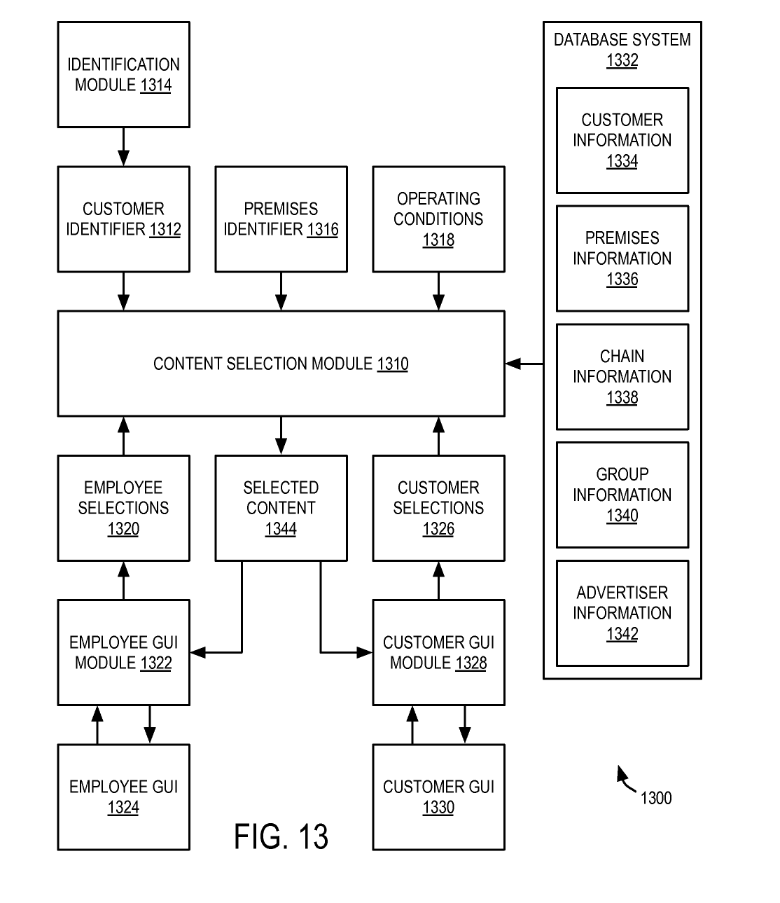

FIG. 13 is a schematic diagram depicting an example process flow 1300 for selecting content for a customer GUI and an employee GUI. In FIG. 13, a content selection module 1310 receives various information inputs and outputs selected content 1344 that may be utilized by employee GUI module 1322 to generate and display an employee GUI 1324 and/or by customer GUI module 1328 to generate and display a customer GUI 1330. Content selection module 1310 is a non-limiting example of previously described content selection modules 770 of FIGS. 7 and 1240 of FIG. 12.

The various information inputs provided to and received by content selection module 1310 may include a customer identifier 1312 received from an identification module 1314, a premises identifier 1316 identifying the public accommodation, operating conditions 1318, employee selections 1320 made by an employee via employee GUI 1324 from an employee GUI module 1322 that interfaces with employee GUI 1324, customer selections 1326 made by a customer via customer GUI 1330 from a customer GUI module 1328 that interfaces with customer GUI 1330, customer information 1334, premises information 1336, chain information 1338, group information 1340, and advertiser information 1342.

The various forms of information depicted at 1334, 1336, 1338, 1340, and 1342 may take the form of account profiles for accounts of different types, including a customer, premises, chain, group, and advertiser, respectively. These account profiles may be maintained at database system 1332, which may reside at an on-premises database system, a remote database system, or may be distributed across the on-premises database system and remote database system. Customer identifier 1312 may be used by content selection module 1310 to access customer information 1334 associated with customer identifier 1312 at database system 1332. Premises identifier 1316 may be used by content selection module 1310 to access premises information 1336 associated with premises identifier 1316 at database system 1332. Premises identifier 1316 may be further used by content selection module 1310 to access chain information 1338 and/or group information 1340 associated with premises identifier 1316 at database system 1332. A premises may be associated with a chain of multiple related premises and/or a group of multiple related premises that spans two or more chains. Content selection module 1310 may additionally access advertiser information 1342 at database system 1332.

Customer information 1334 may include customer profile information as previously discussed. Premises information 1336 is information that is specific to the public accommodation, and may include a database of products and/or services along with price information, inventory information for each product and/or service, options available for each product and/or service of the public accommodations, recommended product and/or service campaigns and associated rule sets, promotional product and/or service campaigns and associated rule sets, brand identity information, GUI layout definitions for the various GUIs presented by the display devices of the public accommodation, and other suitable account information for the public accommodation.

Premises information 1336 is associated with a particular public accommodation via a premises identifier, such as premises identifier 1316. Database system 1332 may include premises information for each public accommodation or for a subset of public accommodations. If, for example, premises information 1336, as a component of database system 1332, resides locally at an on-premises database system of the public accommodation, then premises information 1336 for the public accommodation may be the only premises information residing at the on-premises database system.

Chain information 1338 is information that is specific to the chain of public accommodations, and may include a database of products and/or services along with price information for the chain, inventory information for each product and/or service of the chain, options available for each product and/or service of the chain, recommended product and/or service campaigns and associated rule sets for the chain, promotional product and/or service campaigns and associated rule sets for the chain, brand identity information for the chain, GUI layout definitions for the various GUIs presented by the display devices of the chain of public accommodations, a listing of associated public accommodations that are members of the chain, and other suitable account information for the chain.

Chain information 1338 is associated with one or more particular public accommodations via respective premises identifiers, such as premises identifier 1316. Database system 1332 may include chain information for each chain of public accommodations or for a subset of the chains. If, for example, chain information 1338, as a component of database system 1332, resides locally at an on-premises database system of a public accommodation of the chain then chain information 1338 may be the only chain information residing at the on-premises database system.

Group information 1340 is information that is specific to the group of public accommodations, and may include a database of products and/or services along with price information for the group, inventory information for each product and/or service of the group, options available for each product and/or service of the group, recommended product and/or service campaigns and associated rule sets for the group, promotional product and/or service campaigns and associated rule sets for the group, brand identity information for the group, GUI layout definitions for the various GUIs presented by the display devices of the group of public accommodations, a listing of associated public accommodations that are members of the group and other suitable account information for the group.

Group information 1340 is associated with one or more particular public accommodations via respective premises identifiers, such as premises identifier 1316. Database system 1332 may include group information for each group of public accommodations or for a subset of the groups. If, for example, group information 1340, as a component of database system 1332, resides locally at an on-premises database system of a public accommodation of the group, then group information 1340 may be the only group information residing at the on-premises database system.

Advertiser information 1342 includes recommended and/or promotional product and/or service campaigns and associated rule sets for one or more advertisers, brand identity information for each advertiser, and other suitable account information for each advertiser.

In an example implementation, each menu item or combination of menu items of employee selections 1320 and/or each menu item or combination of menu items of customer selections 1326 may be associated with a respective set of options (e.g., recommended items, promotional items, order augmenting options, item augmenting options, etc.) that may be defined on a per-premises basis based on rules and associated assets contained in premises information 1336, a per-chain basis based on rules and associated assets contained in chain information 1338, a per-group basis based on rules and associated assets contained in group information 1340. As previously described, such options may be based upon customer-specific information 1334.

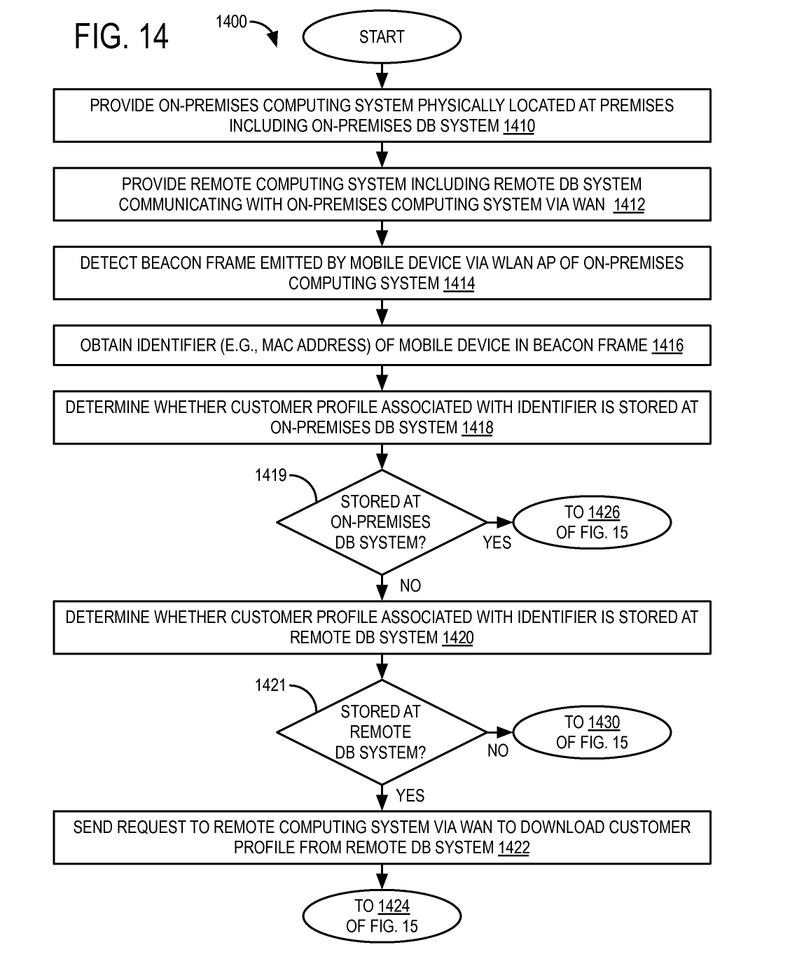

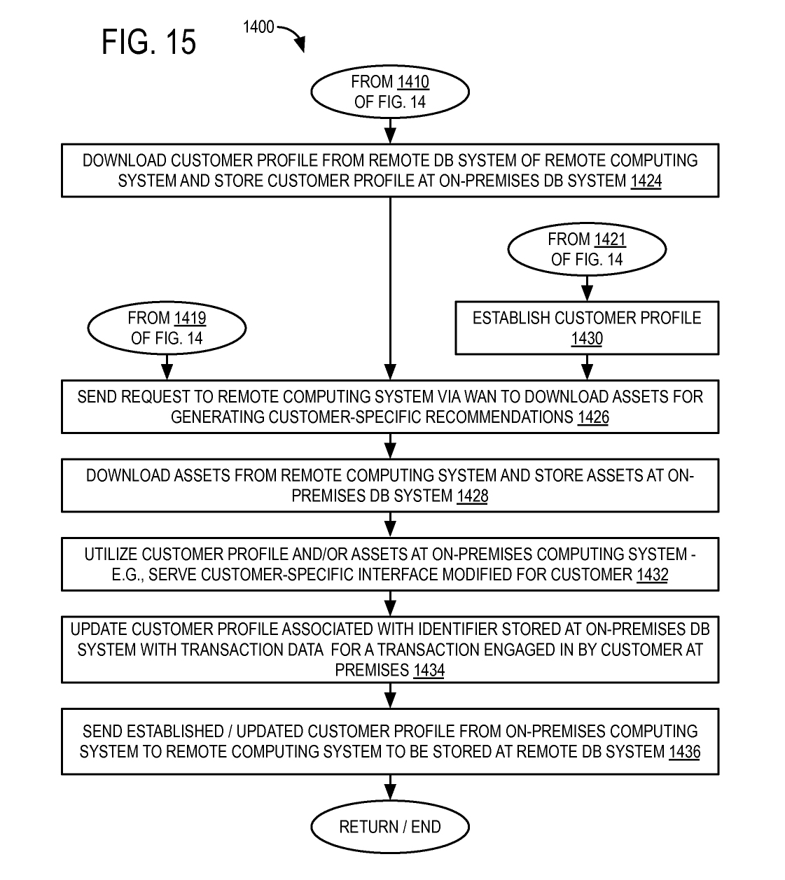

FIGS. 14 and 15 are flow diagrams depicting an example method 1400 for detecting a wireless device (e.g., a mobile wireless device carried by a customer), and retrieving a customer profile and/or assets for the wireless device from either a local on-premises database or a remote database. Method 1400 or portions thereof may be performed by an on-premises computing system (e.g., including an on-premises server component thereof) physically located at a premises of a public accommodation that is visited by a user carrying a wireless device, or may be distributed across the on-premises computing system and a remote computing system.

At 1410, the method includes providing a first on-premises computing system that is physically located at a first premises. The first on-premises computing system has a first on-premises database. At 1412, the method includes providing a remote computing system configured to communicate with the first on-premises computing system via wide area network. The remote computing system has a remote database.

At 1414, the method includes detecting via a wireless local area network access point of the first on-premises computing system, a beacon frame emitted by a wireless device. At 1416, the method includes obtaining an identifier (e.g., a MAC address) of the wireless device in the beacon frame. Operations 1414 and 1416 may refer to an example of previously described operations 926-938 of FIG. 9.

While operations 1414 and 1416 describe detecting a customer's presence via a WLAN in which the customer's wireless device transmits a MAC address in a beacon frame, any of the customer detection and identification techniques described in FIG. 8 may be used in combination with or in place of WLAN MAC address detection. For example, a customer's presence may be detected and identified via customer reported check-in, device reported geo-location, near-field wireless detection at a POS, etc. In at least some implementations, WLAN MAC address detection may be used to identify the customer's presence at the premises and obtain the customer's profile information from a remote computing system prior to a closer-field wireless protocol being used to identify the customer's presence at a particular POS. In this way, customer profile information may be pre-fetched by the local computing system from a remote source so that information associated with the customer profile or information selected based upon the customer profile information may be available for rapid use and deployment at a customer-facing POS and/or employee-facing POS.

At 1418, the method includes determining whether a customer profile associated with the identifier is stored at the first on-premises database. The customer profile may include one or more of (1) a transaction history of the customer at the premises (e.g., store) and/or at one or more other premises (e.g., other stores), (2) customer preferences of the customer, (3) an advertisement or other promotion viewing history of the customer, (4) customer payment information. Customer payment information may be used at the on-premises computing system to process payment requests from in-store point of sale terminal even if a connection to the remote computing system via the wide area network is non-functional or unavailable. In some examples, the viewing history may refer to advertisements previously delivered to the customer's wireless device whether or not the customer actually viewed the advertisement.

At 1419, if the customer profile associated with the identifier is stored at the first on-premises database, then the method proceeds to 1426. If the customer profile associated with the identifier is not stored at the first on-premises database, then the method proceeds to 1420.

At 1420, the method includes determining whether a customer profile associated with the identifier is stored at a remote database. In at least some implementations, the on-premises computing system may access a list of all MAC addresses for customer profiles stored at the remote database. The list of MAC addresses may be stored at the on-premises database of the on-premises computing system. At 1421, if the customer profile associated with the identifier is stored at the remote database, then the method proceeds to 1422. If the customer profile associated with the identifier is not stored at the remote database, then the method proceeds to 1430.

At 1422, the method includes sending a request to the remote computing system via the wide area network to download the customer profile from the remote database. At 1424, the method includes downloading the customer profile from the remote database of the remote computing system via the wide area network and storing the customer profile at the first on-premises database of the first on-premises computing system.

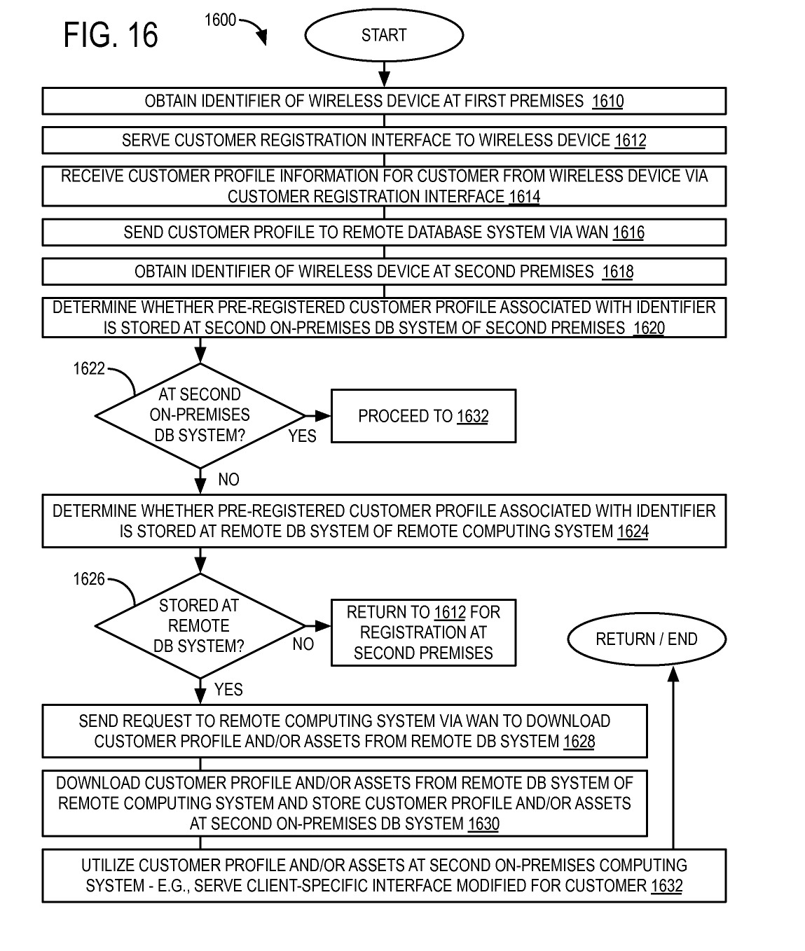

At 1430, the method includes establishing a customer profile if a customer profile is not stored at either of the first on-premises database or the remote database. Establishing a customer profile will be described in further detail with reference to operations 1612-1616 of FIG. 16, for example.

At 1426, the method includes sending a request to the remote computing system via the wide area network to download assets for generating customer-specific recommendations. The request sent at 1426 may include or otherwise indicate the customer identifier. In at least some implementations, the request to download assets may be sent after sending the request to download the customer profile at 1422 and/or after downloading and receiving the customer profile at 1424. Assets may be used at the on-premises computing system to generate customer-specific recommendations. Assets may include media content in the form of image data, video data, audio data, and/or text data, for example. At 1428, the method includes downloading the assets from the remote computing system and storing the assets at the first on-premises database.

At 1432, the method includes utilizing the customer profile and/or the assets at the first on-premises computing system. As one example, assets that are utilized at 1432 for a customer-specific recommendation may be identified and/or selected for use by the on-premises computing system and/or remote computing system based on one or more of (1) the transaction history, (2) the customer preferences, (3) the advertisement viewing history of the customer as indicated by the customer profile, among other customer profile information. Where assets are identified and/or selected for use by the remote computing system, the assets downloaded and stored at 1428 may include a filtered subset of assets available for download from the remote computing system, and the remote computing system may filter assets based on the customer profile information indicated by the request, such as via the customer identifier.

At 1434, the method includes updating the customer profile associated with the identifier stored at the first on-premises database with transaction data for a transaction engaged in by the customer at the first premises. At 1436, the method includes sending the established and/or updated customer profile from the first on-premises computing system to the remote computing system to be stored at the remote database. The process at 1436 may be used to sync the customer profile at the remote database with the established and/or updated customer profile at the on-premises database. In at least some implementations, sending an updated customer profile to another computing system to sync the customer profile across two or more databases may include sending only a portion of the customer profile (e.g., the recently updated portion) that differs among the two or more databases. Time stamps or other time-series identifiers may be utilized and communicated between computing systems to enable synchronization of customer profiles and/or reconciliation of differences between customer profiles across two or more databases.

FIG. 16 is a flow diagram depicting an example method 1600 for establishing and sharing customer profile information among or between multiple premises. Method 1600 or portions thereof may be performed by two or more on-premises computing systems located at different premises.

At 1610, the method includes obtaining an identifier (e.g., MAC address or token) of a wireless device (e.g., a mobile wireless device or other suitable wireless computing device carried by a customer) at a first on-premises computing system of a first premises. The identifier of the wireless device may be obtained as part of the wireless device establishing a network connection with the on-premises computing system via the wireless local area network and on-premises wireless access point of the on-premises computing system.

At 1612, the method includes serving a customer registration interface from the first on-premises computing system to the wireless device for display at the wireless device. In at least some implementations, the customer registration interface may be served to the wireless device in response to a request received from the wireless device. As on example, the request may originate from the wireless device responsive to a user selecting a link in a captive portal interface served by the first on-premises computing system and displayed on the wireless device. As another example, the request may originate from a user selecting a selector in an in-application notification provided by the wireless device. As yet another example, the request may originate from a user selecting a link in an email, social network, or SMS message via the wireless device or other computing device operated by the user.

A network connection between the on-premises computing system and the wireless device may be established via the wireless local area network and the on-premises wireless access point prior to serving the customer recognition interface at 1612. Prior to and as a pre-condition of serving a customer registration interface, the method may further include determining whether the wireless device is associated with a pre-registered customer profile stored at the on-premises database of the on-premises computing system. After determining that the wireless device is not associated with a pre-registered customer profile stored at the on-premises database, and prior to and as a precondition of serving the customer registration interface, the method may further include determining that the wireless device is not associated with a pre-registered customer profile stored at a remote database (e.g., an aggregated database of a remote computing system) linked over a wide area network. These preconditions will be described by way of example with respect to a second on-premises computing system for operations 1620-1626 of method 1600.

At 1614, the method includes receiving customer profile information at the first on-premises computing system from the wireless device for the customer (or other computing device operated by the customer) via the customer registration interface. The customer profile information may be stored in a customer profile at a first on-premises database of the first premises. The customer profile may be associated with the identifier of the wireless device or other suitable customer identifier. The customer profile information may include a customer name and payment data, for example, among other forms of customer profile information described herein. Operations 1610-1614 may refer to a non-limiting example of previously described operations 920-924 of FIG. 9.

At 1616, the method includes sending the customer profile from the first on-premises computing system to a remote database of a remote computing system via a wide area network. The remote database may take the form of an aggregated database by which information is aggregated and synchronized with multiple on-premises databases. The remote computing system stores the customer profile at the remote database in association with a wireless device identifier and/or customer identifier to establish a pre-registered customer profile with respect to subsequent customer visits to the first premises or other premises served by the remote computing system.

At 1618, the method includes, at a second on-premises computing system of a second premises, obtaining an identifier of the wireless device. The method at 1618 may refer to the previously described MAC address detection techniques of operations 926-934 of FIG. 9, for example. However, other suitable customer detection and identification techniques may be used, such as are described in FIG. 8, for example.

At 1620, the method includes determining, at the second on-premises computing system, whether a pre-registered customer profile associated with the identifier is stored at the second on-premises database of the second on-premises computing system. At 1622, if the pre-registered customer profile associated with the identifier is stored at the second on-premises database, then the method proceeds to 1632. If the pre-registered customer profile associated with the identifier is not stored at the second on-premises database, then the method proceeds to 1624.

At 1624, the method includes determining, at the second on-premises computing system, whether the pre-registered customer profile associated with the identifier is stored at the remote database of the remote computing system. As previously described, a list of customer profiles available at the remote database may be stored at the on-premises database for use by the on-premises computing system to determine whether a customer profile has been established (e.g., as a pre-registered customer profile) at any premises or a subset of premises served by the remote computing system. At 1626, if the pre-registered customer profile associated with the identifier is stored at the remote database, then the method proceeds to 1628. If the pre-registered customer profile associated with the identifier is not stored at the remote database, then the method returns to 1612 in which the registration process may be performed for the second premises by the second on-premises computing system as previously described with reference to the first premises.

At 1628, the method includes sending a request from the second on-premises computing system to the remote computing system via the wide area network to download the customer profile associated with the identifier and/or assets for the customer from the remote database.

At 1630, the method includes downloading the customer profile and/or assets at the second on-premises computing system from the remote database of the remote computing system, and storing the customer profile and/or assets at the second on-premises database.

At 1632, the method includes utilizing the customer profile and/or assets at the second on-premises computing system. The method at 1632 may include serving a customer interface from the second on-premises computing system for the second premises (e.g., store) that is particularly modified for the customer based upon information contained in the customer profile. Customer profile information may be used at other premises following registration by the customer to serve interfaces to the customer that are tailored to that particular premises and that individual customer. For example, following operation 1614, the first on-premises computing system may serve a first customer interface to the wireless device, which enables the customer to purchase goods or services at or within the first premises, and the second on-premises computing system may serve a second customer interface (different from the first customer interface), which enables the customer to purchase goods or services at or within the second premises (e.g., including different goods or services in the case of different types of stores, or the same goods or services in the case of similar types of stores).

While FIGS. 14-16 describe serving customer interfaces and/or registration interfaces to a wireless device carried by the customer, it will be understood that these interfaces may alternatively or additionally be served to on-premises display devices such as a POS customer-facing display device or other suitable on-premises display device (e.g., kiosk), for example. Hence, a customer may register and/or place an order via an on-premises display device and/or the customer's wireless device in at least some implementations.

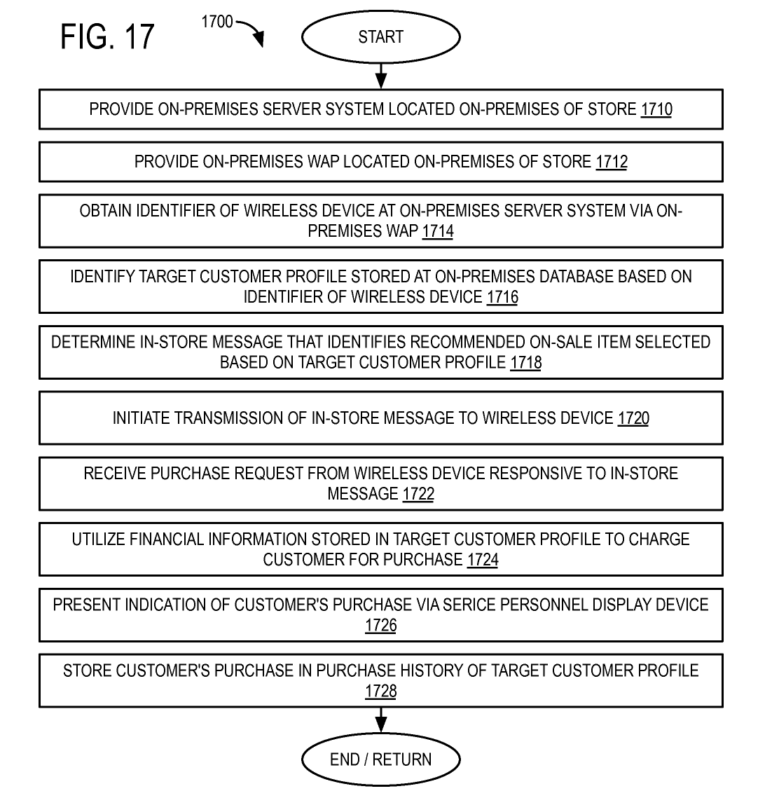

FIG. 17 is a flow diagram depicting an example method 1700 of recognizing customers. Method 1700 or portions thereof may be performed by one or more of the computing systems described herein.

As a non-limiting example, a computing system may include an on-premises server system including one or more server devices located on-premises a store or other public accommodation, and an on-premises wireless access point (WAP) located on-premises of the store that provides wireless local area network (WLAN) coverage to wireless devices over at least a portion of the physical premises of the store. In an example, one or more server devices of the on-premises server system in combination with one or more on-premises WAPs may be configured to perform method 1700 or portions thereof. The method at 1710 and 1712, for example, includes providing an on-premises server system and a WAP located on-premises of a store or other public accommodation.

The on-premises WAP enables wireless devices within wireless communications range of the on-premises WAP to connect to the on-premises WAP over the WLAN and establish HTTP/TCP connections (or other suitable Internet protocol or communications protocol) with the on-premises server system. Additionally, the on-premises WAP further enables wireless devices within wireless communications range of the on-premises WAP to connect to the on-premises WAP over the WLAN and establish connections (e.g., HTTP/TCP connections or other suitable Internet protocol or communication protocol) with remote Internet web servers over a wide area network (WAN) via the on-premises WAP. Hence, customer's carrying wireless devices within wireless communications range of the on-premises WAP can obtain WAN connectivity to Internet resources in addition to or as an alternative to connectivity to on-premises server system. As previously described, the one or more server devices of the on-premises server system may include a data storage system having an on-premises database stored thereon that includes customer profiles of a plurality of customers and information defining on-sale items (e.g., menu items or other suitable product or service) offered for sale by the store.

At 1714, the method includes obtaining, at the on-premises server system, an identifier of a wireless device included in one or more wireless communications received from the wireless device via the on-premises WAP over the WLAN.

At 1716, the method includes identifying a target customer profile from among the customer profiles stored at the on-premises database based on the identifier of the wireless device associated with the target customer profile in the on-premises database or in a remote database. The target customer profile described with reference to method 1700 refers to a particular customer profile associated with a particular customer via the wireless device identifier obtained or otherwise identified at 1714.

At 1718, the method includes determining an in-store message that identifies a recommended on-sale item from the on-sale items stored at the on-premises database. The recommended on-sale item may be selected by the on-premises server system (or alternatively by a remote server system) based on information contained within the target customer profile. Selection of a recommended on-sale item may be performed by previously described content selection module 770, as a non-limiting example.

The recommended on-sale item may take the form of a particular product or service or a particular collection or combination of multiple products or services offered for sale by the store or public accommodation. The recommended on-sale item may be selected based on a transaction history of the customer within the target customer profile, among other suitable information contained within the target customer profile. For example, the transaction history may include transactions for items previously purchased by the customer at the store and/or may include transactions for items previously purchased by the customer from one or more additional stores, which have been aggregated into the target customer profile.

As a non-limiting example, the recommended on-sale item may be selected from a set of available items most frequently purchased or more frequently purchased by the customer at the store or at one or more other stores. As another example, the recommended on-sale item may be selected from a set of available items that the customer has never purchased at the store or at any other store. The recommended on-sale item may be selected further based on inventory of the item at the store, for example, to recommend items that have a relatively higher inventory level compared to other items. The recommended on-sale item may be selected further based on whether the item has been recently offered for purchase at the store, for example, to promote new items.

In at least some implementations, the on-premises server system is configured to determine if the target customer profile is present among the customer profiles stored at the on-premises database. If the target customer profile is not identified as being present among the customer profiles stored at the on-premises database based on the identifier of the wireless device, then the on-premises servers system is configured to send a request message from the on-premises server system to a remote server system over a wide area network (WAN) requesting the target customer profile associated with the identifier of the wireless device. The remote server system is configured to process the request by referencing the remote database and send the requested information (e.g., the target customer profile or a portion thereof) to the on-premises server system. The on-premises server system is configured to receive the target customer profile from the remote server system, and store the target customer profile at the on-premises database of the data storage system.

At 1720, the method includes initiating transmission of the in-store message directed to the wireless device that identifies the recommended on-sale item. The in-store message may take the form of a pre-stored or pre-defined message type selected from a group that includes or consists of an SMS message, an email message, an in-application message, and a captive portal message (e.g., a captive web portal browser page displayed via a browser program).

In at least some implementations, the in-store message further includes or causes an application program operating at the wireless device to present a link (e.g., presented as a graphical selector) selectable by a customer to initiate purchase of the recommended on-sale item identified by the in-store message for fulfillment at the store. The application may take the form of a special-purpose application program that is specifically paired for use with an application program operating at the on-premises server system and/or the remote server system. Alternatively, the application may take the form of a general-purpose application program such as a web browser, email application, SMS application, etc.

In an example implementation of method 1700, the on-premises server system is configured to initiate transmission of the in-store message directed to the wireless device by sending an indication that the wireless device is present at the store to a remote server system over a wide area network (WAN) responsive to obtaining the identifier of the wireless device, the remote server system sending the in-store message to the wireless device over the WAN, including over a wireless WAN edge component of the WAN. The remote server system is configured to receive the indication from the on-premises server system that the wireless device is present at the store, construct the in-store message at the remote server system, and send the in-store message to the wireless device. The in-store message may be sent to the wireless device over the WAN, including over a wireless WAN edge component of the WAN, or alternatively via the WAP over the WLAN. Construction of the in-store message at the remote server system may include selection of the recommended on-sale item from a plurality of on-sale items for the store that are stored in a remote database of the remote server system. Alternatively, the recommended on-sale item may be selected by the on-premises server system and communicated to the remote server system.

In another example implementation of method 1700, the on-premises server system is configured to initiate transmission of the in-store message directed to the wireless device by constructing the in-store message at the on-premises server system, including selection of the recommended on-sale item, sending the in-store message to the wireless device over the WLAN via the WAP. Selection of the recommended on-sale item may be performed by the remote server system in some examples, where an indication of the recommended on-sale may be communicated to the on-premises server system for delivery to the wireless device.

In at least some implementations, the on-premises server system and/or remote server system are configured to initiate transmission of or otherwise send the in-store message to the wireless device only if a user authorization for in-store messaging is present in the target customer profile. This enables the customer to define whether in-store messages are sent to the wireless device on a store by store basis, or across all stores of a particular type or classification. The remote server system and/or on-premises server system may be configured to receive and process requests by the customer to change the customer's settings in the customer profile to reflect whether the customer desires to receive in-store messages.

At 1722, the method includes receiving a purchase request from the wireless device responsive to the in-store message. As one example, selection of the link by the customer causes the wireless device to initiate a purchase request to the one or more server devices of the on-premises server system. Alternatively, selection of the link by the customer causes the wireless device to initiate a purchase request to one or more remote server devices of a remote server system that in-turn forwards or communicates that purchase request to the on-premises server system of the store.

As a non-limiting example, the in-store message may be formatted for a special-purpose application program operating at the wireless device. The special-purpose application program is configured to receive the in-store message and present the in-store message at the wireless device as an in-application notification. The special-purpose application program is further configured to present, via a graphical display of the wireless device, a graphical user interface that includes identification of the recommended on-sale item (e.g., by name, image, video, etc.) and a selector (e.g., representing the link) enabling a customer to purchase the recommended on-sale item for fulfillment at the store.

At 1724, the method includes, responsive to receiving the purchase request, utilizing financial information stored in the target customer profile to charge the customer for the purchase. The on-premises server system and/or the remote server system may be configured to process purchase requests utilizing financial information previously stored in the target customer profile by the customer. As one example, the on-premises server system is configured to programmatically process payment for purchase of the recommended on-sale item based on financial information for the customer within the target customer profile stored at the on-premises database or stored at a remote database accessible to the on-premises server system over a wide area network. In at least some implementations, this previously stored financial information enables the customer to purchase the recommended on-sale item without requiring additional customer input beyond selection by the customer of the selector (e.g., link).

At 1726, the method includes, responsive to receiving the purchase request and/or successful processing of the financial information to charge the customer for the purchase, presenting an indication of the customer's purchase via a service personnel display device for fulfillment by the service personnel at the store. In at least some implementations, the on-premises server system may be configured to direct the indication to the appropriate service personnel display device responsible for fulfilling (e.g., preparing or processing) the item for tendering to the customer at the store.

At 1728, the method includes, responsive to receiving the purchase request and/or successful processing of the financial information to charge the customer for the purchase, storing the customer's purchase in the purchase history of the target customer profile.

In an example implementation of method 1700, the on-premises server system is configured to receive the request via the WAP over the WLAN, and responsive to receiving the request, (1) present an indication of the customer's purchase of the recommended on-sale item via a service personnel display device at the store to be fulfilled by service personnel of the store, (2) utilize financial information stored in or associated with the target customer profile or at a remote database accessible to the on-premises server system via a WAN to charge the customer for the purchase of the recommended on-sale item, and (3) store the customer's purchase in a purchase history for the customer in the target customer profile at the on-premises server system.

In another example implementation of method 1700, the remote server system is configured to receive an indication of the customer's purchase of the recommended on-sale item via the WAN (e.g., as a purchase request), including in some example, the wireless WAN edge component of the WAN, and forward the indication of the customer's purchase of the recommended on-sale item to the on-premises server system. The on-premises server system is configured to, responsive to receiving the indication (e.g., purchase request) at the on-premises server system, present an indication of the customer's purchase of the recommended on-sale item via a service personnel display device at the store to be fulfilled by service personnel of the store.

The remote server system or the on-premises server system, responsive to receiving the purchase request or indication of purchase, utilize financial information stored in the target customer profile at the remote sever system in a remote database or at the on-premises server system in the on-premises database to charge the customer for the purchase of the recommended on-sale item. The remote server system and/or the on-premises server system may each store the customer's purchase in a purchase history for the customer in their respective databases in association with a customer profile (i.e., the target customer profile) for the customer.

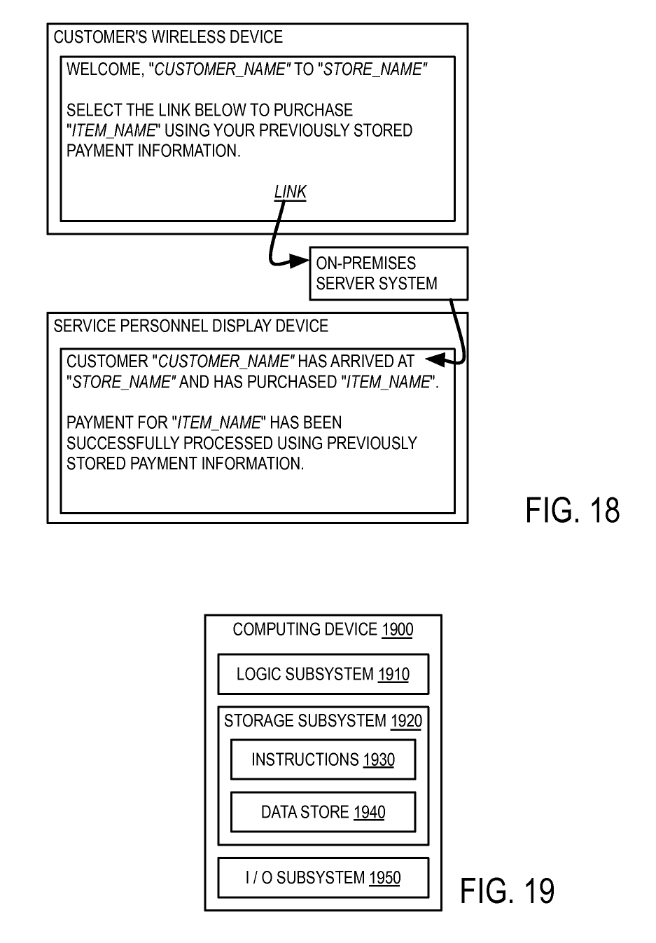

FIG. 18 depicts an example interaction between a customer's wireless device, an on-premises server system, and a service personnel display device (e.g., an employee-facing display device). An example graphical user interface is depicted in FIG. 18 being displayed by a customer's wireless device. The graphical user interface presents an example in-store message “Welcome, ‘CUSTOMER_NAME’ to ‘STORE NAME’ select the link below to purchase ‘ITEM_NAME’ using your previously stored payment information” followed by a link or selector represented as ‘LINK’. In this example, CUSTOMER_NAME refers to the name of the customer associated with the target customer profile, STORE_NAME refers to the name of the store at which the customer is detected as being present via the customer's wireless device, ITEM_NAME refers to a recommended on-sale item, and LINK refers to the link or selector that initiates purchase of the recommended on-sale item upon selection by the customer.

The on-premises server system (or alternatively or additionally the remote server system) processes the customer's selection of the link or selector ‘LINK’ by presenting an indication of purchase of the recommended on-sale item via the appropriate service personnel display device of the appropriate store. For example, the service personnel display device presents a graphical user interface that indicates the customer's name (e.g., CUSTOMER_NAME), the store name (e.g., STORE_NAME), the item that has been purchased (e.g., ITEM_NAME), and that payment has been successfully processed via the stored financial information so that the service personnel can fulfill the order. In at least some implementations, if the financial information has not been successfully processed or is not stored in or associated with the customer's profile, the service personnel may be notified via the service personnel display device so that the service personnel can obtain the financial information from the customer to complete the purchase before fulfilling the order.

As previously discussed, the above described methods and processes may be tied to a computing system including one or more computing devices. In particular, the methods and processes described herein may be implemented as one or more applications, services, application programming interfaces, computer libraries, and/or other suitable computer programs or instruction sets.

FIG. 19 is a schematic diagram depicting an example computing device 1900 that may perform one or more of the above described methods and processes. Computing device 1900 is shown in simplified form. It is to be understood that virtually any computer architecture may be used without departing from the scope of this disclosure. Computing device 1900 or portions thereof may take the form of one or more of a server device or server system, a client computing device, a desktop computer, a laptop computer, a tablet computer, a network computing device, a wireless device, a mobile computing device, a mobile communication device, a wearable computing device (e.g., a watch or glasses), etc. As one example, customer-facing display devices and/or employee-facing display devices may take the form of mobile computing devices, tablet computers, or wearable devices. In the context of a server system, computing device 1900 may take the form of one or more server devices that are co-located at a common location or geographically distributed across two or more locations.

Computing device 1900 includes a logic subsystem 1910 and a computer readable information storage subsystem 1920. Computing device 1900 may further include an input/output subsystem 1950. Logic subsystem 1910 includes one or more tangible, physical devices configured to execute instructions, such as example instructions 1930 held in storage subsystem 1920. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 1910 may include one or more processors that are configured to execute software instructions. Additionally or alternatively, the logic subsystem may include one or more logic machines configured to execute hardware or firmware instructions. The logic subsystem may optionally include individual components that are distributed throughout two or more devices, which may be remotely located and/or configured for coordinated processing.

Storage subsystem 1920 includes one or more tangible, physical, non-transitory, devices configured to hold data in data store 1940 and/or instructions 1930 executable by the logic subsystem to implement the herein described methods and processes. When such methods and processes are implemented, the state of storage subsystem 1920 may be transformed (e.g., to hold different data or other suitable forms of information).

Storage subsystem 1920 may include removable media and/or built-in devices. Storage subsystem 1920 may include optical memory devices, semiconductor memory devices, and/or magnetic memory devices, among others. Storage subsystem 1920 may include devices with one or more of the following characteristics: volatile, nonvolatile, dynamic, static, read/write, read-only, random access, sequential access, location addressable, file addressable, and content addressable. In at least some implementations, the logic subsystem and storage subsystem may be integrated into one or more common devices, such as an application specific integrated circuit or a system on a chip.

The terms “module” or “program” may be used to describe an aspect of a computing device that is implemented to perform one or more particular functions. In some cases, such a module or program may be instantiated via logic subsystem 1910 executing instructions held by storage subsystem 1920. It is to be understood that different modules or programs may be instantiated from the same application, service, code block, object, library, routine, API, function, etc. Likewise, the same module or program may be instantiated by different applications, services, code blocks, objects, routines, APIs, functions, etc. The terms “module” or “program” are meant to encompass individual or groups of executable files, data files, libraries, drivers, scripts, database records, etc. Examples of software include an operating system, an application program such as the previously described authoring application program and/or viewer application program, a plug-in, a software update, a software portion, or combinations thereof.

It is to be appreciated that a “service”, as used herein, may be an application program or other suitable instruction set executable across multiple sessions and available to one or more system components, programs, and/or other services. In at least some implementations, a service may run on a server or collection of servers responsive to a request from a client.

Input/output subsystem 1950 may include and/or otherwise interface with one or more input devices and/or output devices. Examples of input devices include a keyboard, keypad, touch-sensitive graphical display device, touch-sensitive panel, a computer mouse, a pointer device, a controller, an optical sensor, a motion and/or orientation sensor (e.g., an accelerometer, inertial sensor, gyroscope, tilt sensor, etc.), an auditory sensor, a microphone, etc. Examples of output devices include a graphical display device, a touch-sensitive graphical display device, an audio speaker, a haptic feedback device (e.g., a vibration motor), etc. When included, a graphical display device may be used to present a visual representation of data held by the storage subsystem. As the herein described methods and processes change the data held by the storage subsystem, and thus transform the state of the storage subsystem, the state of the graphical display may likewise be transformed to visually represent changes in the underlying data.

Input/output subsystem 1950 may further include a communication subsystem that is configured to communicatively couple computing device 1900 with one or more other computing devices or computing systems. The communication subsystem may include wired and/or wireless communication devices compatible with one or more different communication protocols. As an example, the communication subsystem may be configured for communication via a wireless telephone network, a wireless local area network, a wired local area network, a wireless personal area network, a wired personal area network, a wireless wide area network, a wired wide area network, etc. In at least some implementations, the communication subsystem may enable the computing device to send and/or receive messages to and/or from other devices via a communications network such as the Internet, for example.

In the context of the various display devices (employee-facing, customer-facing, etc.) described herein, input/output subsystem 1950 may include a display device that is integrated into a computing device, such as example computing device 1900 that includes logic subsystem 1910 and storage subsystem 1920. For interactive display devices or display devices that present an interactive GUI, the computing device may include an application program (or other suitable module) that is paired with and configured to interface with a GUI/display module of a local computing system (e.g., an on-premises server system) of a public accommodation. This application program may be configured to present portions of a GUI, such as the GUI framework upon which context-specific information received from the local computing system is presented. An application program (or other suitable module) of a client computing device having an integrated display device communicates with the local computing system by sending and receiving messages that contain information reported to or received from the local computing system.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

While the term “customer” is used throughout to designate a person who visits a public accommodation, it will be appreciated that the person need not be shopping within the public accommodation, and thus “customer” should be understood to encompass guests who are present but not seeking to engage in any financial transaction with the public accommodation, such as visitors to a park. The term “user” may be at times used to refer to a person (e.g., customer or employee) that operates a computing device, interacts with a display device, or other user operable electronic device.

The subject matter of the present disclosure includes all novel and nonobvious combinations and subcombinations of the various processes, systems and configurations, and other features, functions, acts, and/or properties disclosed herein, as well as any and all equivalents thereof. It should be understood that the disclosed embodiments are illustrative and not restrictive. Variations to the disclosed embodiments that fall within the metes and bounds of the claims, now or later presented, or the equivalence of such metes and bounds are embraced by the claims.

1. A computing system, comprising:
an on-premises server system including one or more server devices located on-premises of a store; and
an on-premises wireless access point (WAP) located on-premises of the store that provides wireless local area network (WLAN) coverage to wireless devices over at least a portion of the premises of the store, the on-premises WAP enabling wireless devices within wireless communications range of the on-premises WAP to connect to the on-premises WAP over the WLAN;
one or more server devices of the on-premises server system including a data storage system having an on-premises database stored thereon, the on-premises database including customer profiles of a plurality of customers and information defining on-sale items offered for sale by the store,
one or more server devices of the on-premises server system configured to:
obtain an identifier of a wireless device included in one or more wireless communications received from the wireless device via the on-premises WAP over the WLAN,
identify a target customer profile from among the customer profiles stored at the on-premises database based on the identifier of the wireless device associated with the target customer profile in the on-premises database,
determine an in-store message that identifies a recommended on-sale item from the on-sale items stored at the on-premises database, the recommended on-sale item selected based on the target customer profile; and
initiate transmission of the in-store message directed to the wireless device that identifies the recommended on-sale item.

2. The computing system of claim 1, wherein the in-store message further includes a link selectable by a customer to initiate purchase of the recommended on-sale item identified by the in-store message for fulfillment at the store.

3. The computing system of claim 2, wherein selection of the link by the customer causes the wireless device to initiate a request to the one or more server devices of the on-premises server system; and
wherein the one or more server devices of the on-premises server system are further configured to:
receive the request via the WAP over the WLAN,
responsive to receiving the request, present an indication of the customer's purchase of the recommended on-sale item via a service personnel display device at the store to be fulfilled by service personnel of the store.

4. The computing system of claim 3, wherein the one or more server devices of the on-premises server system are further configured to:
responsive to receiving the request, utilize financial information stored in the target customer profile or at a remote database accessible to the on-premises server system via a WAN to charge the customer for the purchase of the recommended on-sale item, and
store the customer's purchase in a purchase history for the customer in the target customer profile at the on-premises server system.

5. The computing system of claim 2, wherein the one or more server devices of the on-premises server system are further configured to:
initiate transmission of the in-store message directed to the wireless device by:
sending an indication that the wireless device is present at the store to a remote server system over a wide area network (WAN) responsive to obtaining the identifier of the wireless device, the remote server system sending the in-store message to the wireless device over the WAN, including over a wireless WAN edge component of the WAN.

6. The computing system of claim 5, further comprising the remote server system, the remote server system including one or more remote servers configured to:
receive the indication from the on-premises server system that the wireless device is present at the store;
construct the in-store message at the remote server system; and
send the in-store message to the wireless device over the WAN, including over the wireless WAN edge component of the WAN.

7. The computing system of claim 6, wherein the one or more remote server devices of the remote server system are further configured to:
receive an indication of the customer's purchase of the recommended on-sale item via the WAN, including the wireless WAN edge component of the WAN, and
forward the indication of the customer's purchase of the recommended on-sale item to the on-premises server system; and
wherein the one or more server devices of the on-premises server system are further configured to:
responsive to receiving the indication at the on-premises server system, present an indication of the customer's purchase of the recommended on-sale item via a service personnel display device at the store to be fulfilled by service personnel of the store.

8. The computing system of claim 7, wherein the one or more remote server devices of the remote server system are further configured to:
responsive to receiving the request, utilize financial information stored at the remote sever system in a remote database to charge the customer for the purchase of the recommended on-sale item,
store the customer's purchase in a purchase history for the customer in the remote database in association with a customer profile for the customer.

9. The computing system of claim 1, wherein the in-store message is formatted for a special-purpose application program operating at the wireless device, the special-purpose application program configured to receive the in-store message and present the in-store message at the wireless device as an in-application notification; and
wherein the special-purpose application program is configured to present, via a graphical display of the wireless device, a graphical user interface that includes identification of the recommended on-sale item and a selector enabling a customer to purchase the recommended on-sale item for fulfillment at the store.

10. The computing system of claim 1, wherein the one or more server devices of the on-premises server system are further configured to:
if the target customer profile is not identified as being present among the customer profiles stored at the on-premises database based on the identifier of the wireless device, then:
send a request message from the on-premises server system to a remote server system over a wide area network (WAN) requesting the target customer profile associated with the identifier of the wireless device;
receive the target customer profile from the remote server system; and
store the target customer profile at the on-premises database of the data storage system.

11. The computing system of claim 1, wherein the one or more server devices of the on-premises server system are further configured to programmatically process payment for purchase of the recommended on-sale item based on financial information for the customer within the target customer profile stored at the on-premises database or stored at a remote database accessible to the on-premises server system over a wide area network without requiring additional customer input beyond selection by the customer of the selector.

12. The computing system of claim 1, wherein the on-premises WAP further enables wireless devices within wireless communications range of the on-premises WAP to connect to the on-premises WAP over the WLAN and establish HTTP connections with remote Internet web servers over a wide area network (WAN) via the on-premises WAP.

13. The computing system of claim 1, wherein the in-store message is of a pre-stored message type selected from a group consisting of SMS message, email message, in-application message, and captive portal message.

14. The computing system of claim 1, wherein the recommended on-sale item is selected based on a transaction history of the customer within the target customer profile.

15. The computing system of claim 14, wherein the transaction history includes transactions for the store.

16. The computing system of claim 15, wherein the transaction history includes transactions from one or more additional stores, which have been aggregated into the target customer profile.

17. The computing system of claim 1, wherein the one or more server devices of the on-premises server system are further configured to initiate transmission of the in-store message directed to the wireless device only if a user authorization for in-store messaging is present in the target customer profile.

18. The computing system of claim 1, wherein the one or more server devices of the on-premises server system are further configured to initiate transmission of the in-store message directed to the wireless device by:
construct the in-store message at the on-premises server system, including selection of the recommended on-sale item; and
send the in-store message to the wireless device over the WLAN via the WAP.

19. A method for in-store messaging of a customer, comprising:
providing an on-premises server system including one or more server devices located on-premises of a store, one or more server devices of the on-premises server system including a data storage system having an on-premises database stored thereon, the on-premises database including customer profiles of a plurality of customers and information defining on-sale items offered for sale by the store; and
providing an on-premises wireless access point (WAP) located on-premises of the store that provides wireless local area network (WLAN) coverage to wireless devices over at least a portion of the premises of the store, the on-premises WAP enabling wireless devices within wireless communications range of the on-premises WAP to connect to the on-premises WAP over the WLAN and establish HTTP connections with the on-premises server system;
the one or more server devices of the on-premises server system configured to:
obtain an identifier of a wireless device included in one or more wireless communications received from the wireless device via the on-premises WAP over the WLAN,
identify a target customer profile from among the customer profiles stored at the on-premises database based on the identifier of the wireless device associated with the target customer profile in the on-premises database,
determine an in-store message that identifies a recommended on-sale item from the on-sale items stored at the on-premises database, the recommended on-sale item selected based on the target customer profile; and
initiate transmission of the in-store message directed to the wireless device that identifies the recommended on-sale item and further includes a link selectable by a customer to initiate purchase of the recommended on-sale item identified by the in-store message for fulfillment at the store.

20. A computerized method for in-store messaging of a customer, comprising:
at one or more server devices of an on-premises server system located on-premises of a store:
obtaining an identifier of a wireless device included in one or more wireless communications received from the wireless device via an on-premises WAP over a WLAN,
identifying a target customer profile from among a plurality of customer profiles stored at an on-premises database of the on-premises server system based on the identifier of the wireless device associated with the target customer profile in the on-premises database,
determining an in-store message that identifies a recommended on-sale item from a plurality of on-sale items stored at the on-premises database, the recommended on-sale item selected based on the target customer profile including a transaction history of the customer within the target customer profile; and
initiating transmission of the in-store message via the on-premises WAP over the WLAN directed to the wireless device that identifies the recommended on-sale item by constructing the in-store message at the on-premises server system, and sending the in-store message to the wireless device over the WLAN via the on-premises WAP;
wherein the in-store message is presented at the wireless device with a selector that enables a customer to select the selector to initiate purchase of the recommended on-sale item for fulfillment at the store.
